(19) United States
(12) Patent Application Publication
(10) Pub. No.: US 2026/0099119 A1
(43) Pub. Date: Apr. 9, 2026

(54) SHEET BONDING APPARATUS, SHEET PROCESSING APPARATUS, AND IMAGE FORMING APPARATUS

(71) Applicant: CANON KABUSHIKI KAISHA, Tokyo (JP)

(72) Inventors: KENJI TAKAGI, Kanagawa (JP); KENICHIROU ISOBE, Kanagawa (JP); TETSUYA SANO, Shizuoka (JP)

(21) Appl. No.: 19/347,818

(22) Filed: Oct. 2, 2025

(30) Foreign Application Priority Data
Oct. 4, 2024 (JP) 2024-174750
Sep. 8, 2025 (JP) 2025-148621

(51) Int. Cl. G03G 15/00; B42C 1/12

(52) U.S. Cl. CPC G03G 15/6544; B42C 1/12; G03G 15/6585; G03G 2215/00835; G03G 2215/00936

(57) ABSTRACT

A sheet bonding apparatus includes a first nipping member having a first surface and for nipping a sheet bundle on which a toner image for bonding sheets together is formed, a heating portion configured to heat the first surface of the first nipping member, and a second nipping member having a second surface opposing the first surface and configured to bond the sheet bundle in an adhesive region by heating and pressing the toner image while nipping the sheet bundle by the first surface and the second surface. At least one of the first surface and the second surface includes a plurality of uneven portions for forming an uneven shape on the sheet bundle in the adhesive region.

### BACKGROUND

### Field of the Technology

The present disclosure relates to a sheet bonding apparatus for bonding sheets together, a sheet processing apparatus including the sheet bonding apparatus, and an image forming apparatus including the sheet processing apparatus.

### Description of the Related Art

According to Japanese Laid-Open Application No. 2013-43751, a staple apparatus such that a toner pattern for bonding formed on a corner of each of a plurality of sheets to be stacked is heated and pressed by a pair of heaters and thus a sheet bundle is formed by bonding the plurality of sheets together is proposed. This staple apparatus is constituted so that a pixel ratio, an area ratio, a thickness, a color and a pattern of the toner pattern for bonding is capable of being changed depending on a bonding force of the sheet bundle.

In recent years, a further improvement in adhesive strength of the sheet bundle has been required.

### SUMMARY

The present disclosure is directed to provide a form of sheet bonding apparatus, a sheet processing apparatus, and an image forming apparatus which are capable of improving adhesive strength of a sheet bundle.

According to an aspect of the present disclosure, there is provided a sheet bonding apparatus comprising: a first nipping member having a first surface and configured to nip a sheet bundle on which a toner image for bonding sheets together is formed; a heating portion configured to heat the first surface of the first nipping member; and a second nipping member having a second surface opposing the first surface and configured to bond the sheet bundle in an adhesive region by heating and pressing the toner image while nipping the sheet bundle by the first surface and the second surface, wherein at least one of the first surface and the second surface includes a plurality of uneven portions for forming an uneven shape on the sheet bundle in the adhesive region.

According to another aspect of the present disclosure, there is provided a sheet bonding apparatus comprising: a first nipping member having a first surface and configured to nip a sheet bundle on which a toner image for bonding sheets together is formed; a heating portion configured to heat the first surface of the first nipping member; and a second nipping member having a second surface opposing the first surface and configured to bond the sheet bundle in an adhesive region by heating and pressing the toner image while nipping the sheet bundle by the first surface and the second surface, wherein the first surface and the second surface are constituted so as to forming an uneven shape on the sheet bundle in the adhesive region by nipping the sheet bundle therebetween.

Features of the present disclosure will become apparent from the following description of embodiments with reference to the attached drawings. The following description of embodiments are described by way of example.

### BRIEF DESCRIPTION OF THE DRAWINGS

FIG. 1 is an entire schematic view showing an image forming apparatus according to a first embodiment.

FIG. 2 is a schematic view showing a thermocompression bonding portion.

Part (a) of FIG. 3 is a front view showing a first nipping surface of a heating plate, part (b) of FIG. 3 is a side view showing the first nipping surface of the heating plate, part (c) of FIG. 3 is a front view showing a second nipping surface of a pressing plate, and part (d) of FIG. 3 is a side view showing the second nipping surface of the pressing plate.

FIG. 4 is a schematic view showing an arrangement of an adhesive layer formed on a sheet.

Part (a) of FIG. 5 is a schematic view of the heating plate and the pressing plate as viewed in a Z direction, and part (b) of FIG. 5 is a sectional view showing a sheet bundle pressed by the heating plate and the pressing plate.

Part (a) of FIG. 6 is a sectional view showing a sheet bundle pressed by the first nipping surface and the second nipping surface, and part (b) of FIG. 6 is a sectional view showing the pressed sheet bundle and the adhesive layer.

FIG. 7 is a graph showing a relationship of tensile strength of the sheet bundle relative to a thickness of the adhesive layer.

FIG. 8 is a schematic view showing a state of a test for measuring the tensile strength of the sheet bundle.

Part (a) of FIG. 9 is a perspective view showing a cross section of an “uneven model”, and part (b) of FIG. 9 is a perspective view showing a cross section of a “no uneven model”.

FIG. 10 is a graph showing a simulation result of analysis of maximum stress exerted on an adhesive region.

Part (a) of FIG. 11 is a schematic view showing a state when the “no uneven model” is pulled, and part (b) of FIG. 11 is a schematic view showing a state when the “uneven model” is pulled.

Part (a) of FIG. 12 is a schematic view of a portion enclosed by a chain line in part (a) of FIG. 11 as viewed in an arrow Yb direction, and part (b) of FIG. 12 is a schematic view of a portion enclosed by a chain line in part (b) of FIG. 11 as viewed in an arrow Yb direction.

Part (a) of FIG. 13 is a front view showing a first nipping surface of a heating plate in a second embodiment, part (b) of FIG. 13 is a side view showing the first nipping surface, and part (c) of FIG. 13 is a front view showing a second nipping surface of a pressing plate in the second embodiment, and part (d) of FIG. 13 is a side view showing the second nipping surface.

FIG. 14 is a schematic view showing an arrangement of an adhesive layer formed on a sheet.

Part (a) of FIG. 15 is a schematic view of a heating plate and a pressing plate as viewed in a Z direction, part (b) of FIG. 15 is a sectional view showing a sheet bundle pressed by the heating plate and the pressing plate, and part (c) of FIG. 15 is a schematic view showing an example of an opening direction (speed direction) different from an opening direction in part (a) of FIG. 15.

Part (a) of FIG. 16 includes schematic views of a comparison experiment between the first embodiment and the second embodiment in an opening direction G (θ=45°) and schematic views each showing an associated time transition of tension in the comparison experiment, and part (b) of FIG. 16 includes schematic views of a comparison experiment between the first embodiment and the second embodiment in an opening direction G′ (θ=0°) and schematic views each showing an associated time transition of tension in the comparison experiment.

Part (a) of FIG. 17 is a front view showing a first nipping surface of a heating plate in a modified embodiment 1 of the second embodiment, part (b) of FIG. 17 is a side view showing the first nipping surface, part (c) of FIG. 17 is a front view showing a second nipping surface of a pressing plate in the modified embodiment 1, and part (d) of FIG. 17 is a side view showing the second nipping surface.

Part (a) of FIG. 18 is a schematic view showing a shape of an adhesive region as an example of a modified embodiment 2 of the second embodiment, and part (b) of FIG. 18 is a schematic view showing a shape of an adhesive region as another example of the modified embodiment 2.

FIG. 19 is a schematic view showing a thermocompression bonding portion in a third embodiment.

Part (a) of FIG. 20 is a schematic view showing an uneven portion of a heating plate in the third embodiment, part (b) of FIG. 20 is a schematic view showing an uneven portion of a heating plate in a modified embodiment of the third embodiment.

Part (a) of FIG. 21 is a perspective view showing a heating plate in a fourth embodiment, part (b) of FIG. 21 is a schematic view showing a plurality of uneven portions having a twill line shape, and part (c) of FIG. 21 is a sectional view showing the plurality of uneven portions.

### DESCRIPTION OF THE EMBODIMENTS

In the following, embodiments according to the present disclosure will be described with reference to the drawings. Incidentally, in the present disclosure, an “image forming apparatus” widely includes apparatuses, for forming (recording) images on recording materials (recording media) such as a monofunction printer, a copying machine, a multi-function machine, and a commercial printing machine. Further, the image forming apparatus may also be a system (image forming system) in which an image forming apparatus main assembly for forming an image on a recording material and equipment such as a sheet processing apparatus or a sheet feeding apparatus are connected each other.

### First Embodiment

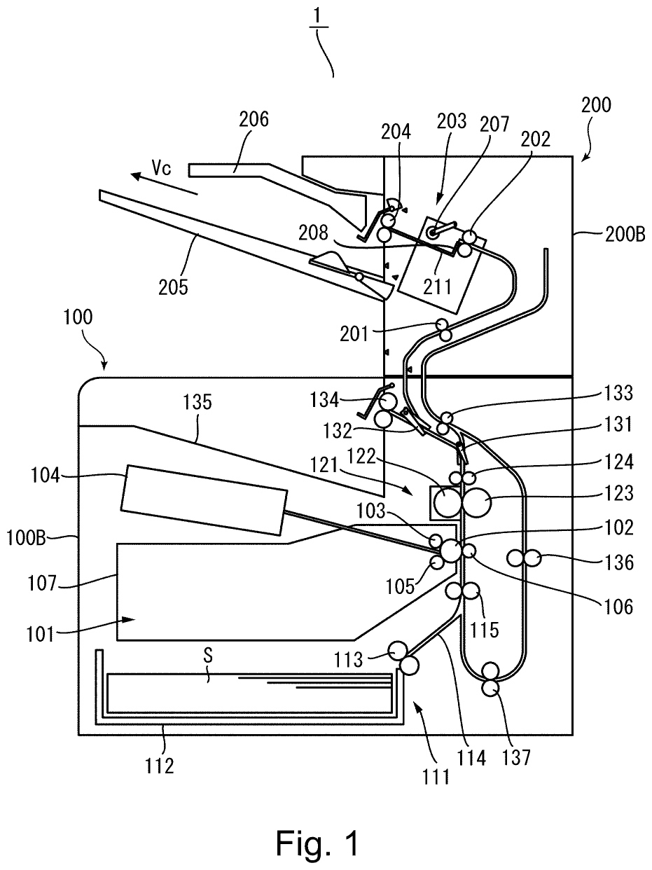

First, an outline of an image forming apparatus 1 according to a first embodiment will be described while making reference to FIG. 1. The image forming apparatus 1 includes a printer main body 100 as an image forming apparatus main assembly and a sheet processing apparatus 200 having a sheet bonding function. That is, the image forming apparatus 1 can also be said as an image forming system constituted by the printer main body 100 functioning as the image forming apparatus even alone and the sheet processing apparatus 200.

The image forming apparatus 1 of this embodiment is capable of preparing a booklet through printing and bookbinding by a single apparatus in a manner such that an image is formed on sheets S one by one by the printer main body 100 and then a plurality of sheets S is subjected to thermocompression bonding in the sheet processing apparatus 200. Incidentally, as the sheet S, it is possible to use various sheet materials, different in size and shape, including paper such as plain paper or thick paper, a sheet material such as coated paper subjected to surface treatment, a plastic film, a cloth, a special-shaped sheet material such as an envelope or index paper, and the like.

### (Printer Main Body)

The printer main body 100 executes an image forming operation in which an image (toner image, developer image) is formed on a sheet S with toner while conveying the sheet S, which is the recording material, one by one, and the sheet S is discharged to the sheet processing apparatus 200. The printer main body 100 includes an image forming portion 101 accommodated inside a casing 100B. The image forming portion 101 is an electrophotographic unit of a direct transfer type. The image forming portion 101 includes a photosensitive drum 102 as an image bearing member, a charging roller 103, an exposure device 104, a developing roller 105, a transfer roller 106, and a toner container 107. The photosensitive drum 102 is a photosensitive member molded in a drawn shape.

In the toner container 107, black toner as a developer and powder adhesive is accommodated. That is, the toner in this embodiment is the developer for recording the image on the sheet S, and in addition, the powder adhesive for bonding sheets together by adhesive processing (thermocompression bonding) in the sheet processing apparatus 200. Incidentally, the developer for recording the image on the sheet may be constituted by toner and the powder adhesive for bonding the sheets together may be constituted by toner different from the toner for the developer.

When a start of the image forming operation is required for the printer main body 100, the photosensitive drum 102 of the image forming portion 101 is rotationally driven. A surface of the photosensitive drum 102 is electrically charged uniformly by the charging roller 103, and then is exposed to light by the exposure device 104. The exposure device 104 exposes the photosensitive drum 102 to light on the basis of image information inputted from an external information processing apparatus, and thus forms an electrostatic latent image on the surface of the photosensitive drum 102. The developing roller 105 supplies the toner to the photosensitive drum 102 and visualizes the electrostatic latent image into a toner image. As described later, in this embodiment, a toner image (second toner image, toner image for recording) for recording the image on the sheet S and a toner image (first toner image, toner image for bonding) for bonding the sheets together are formed simultaneously.

Further, the printer main body 100 includes a sheet feeding portion 111 for feeding the sheet S and a fixing portion 121 for fixing the toner image on the sheet S. The sheet feeding portion 111 includes a feeding cassette 112 accommodating sheets S and a feeding roller 113. The fixing portion 121 is a fixing device of a heat fixing type in which the toner image is fixed on the sheet S under application of heat and pressure to the toner image. The fixing portion 121 includes, for example, a fixing roller 122 as a fixing member, a pressing roller 123 as a pressing member press-contacted to the fixing member, and a heating device for heating the fixing member. As the heating device, it is possible to a halogen lamp generating radiation heat, a heater substrate including a heat generating resistor, an induction heating mechanism for generating heat in an electroconductive layer in the fixing roller 122, and the like.

The sheet feeding portion 111 feeds sheets S, accommodated in the feeding cassette 112, one by one toward the image forming portion 101. The sheet S fed from the sheet feeding portion 111 passes through a guiding portion 114 and is subjected to correction of oblique movement by a registration roller pair 115, and thereafter, the sheet S is sent into a transfer nip between the photosensitive drum 102 and the transfer roller 106. In the transfer nip, the toner image is transferred from the photosensitive drum 102 onto the sheet S. The sheet S passed through the transfer nip is heated and pressed while being nipped and conveyed by the fixing roller 122 and the pressing roller 123 of the fixing portion 121. By this, the toner is melted, so that the image fixed on the sheet S is obtained.

The sheet S passed through the fixing portion 121 is conveyed by a conveying roller pair 124 and is guided to a conveying path selected by a first switching guide 131. In the case of double-side printing in which images are formed on double (both) sides (surfaces) of the sheet S, the sheet S on which first surface the image is formed is guided to a reverse roller pair 133 by the first switching guide 131. Then, the sheet S is switch-backed by the reverse roller pair 133, and thereafter is conveyed again to the image forming portion 101 through double-side conveying roller pairs 136 and 137, so that an image is formed on a second surface opposite from the first surface of the sheet S.

In the case of one-side printing in which the image is formed on one side of the sheet S or in the case where formation of the image on the second surface is ended, the sheet S is guided to a second switching guide 132 by the first switching guide 131 and then is guided to a conveying path selected by the second switching guide 132. In the case where the sheet S is not subjected to processing (post-processing) by the sheet processing apparatus 200, the sheet S is guided to a discharging roller pair 134 by the second switching guide 132. The discharging roller pair 134 discharges the sheet S to an outside of the casing 100B of the printer main body 100, so that the sheet S is stacked on a discharge tray 135 provided at an upper portion of the casing 100B. Further, in the case where the sheet S is subjected to the processing (post-processing) by the sheet processing apparatus 200, the sheet S is sent to the sheet processing apparatus 200.

### (Sheet Processing Apparatus)

Next, the sheet processing apparatus 200 will be described. As shown in FIG. 1, the sheet processing apparatus 200 is mounted to the upper portion of the casing 100B of the printer main body 100.

In a processing apparatus main body 200B of the sheet processing apparatus 200, an inlet roller pair 201, a thermocompression bonding portion 203, and a discharging roller pair 204 are provided, and a stage roller pair 202, a jogger 206, an aligning roller 207, a processing stage 211, and a discharge tray 205 are provided. The thermocompression bonding portion 203 is an example of a sheet bonding apparatus (bonding unit, bonding portion, thermocompression bonding portion, bonding processing portion) for bonding sheets together.

The inlet roller pair 201 receives the sheet S discharged from the printer main body 100 and conveys toward the thermocompression bonding portion 203. The stage roller pair 202 conveys the sheet S, conveyed from the inlet roller pair 201, to the processing stage 211. The processing stage 211 is an example of a stacking portion (intermediary stacking portion) where a sheet bundle which is a processing object of the thermocompression bonding portion 203. Further, the inlet roller pair 201 and the stage roller pair 202 are an example of a conveying portion for stacking sheets on a stacking portion by conveying the sheets one by one.

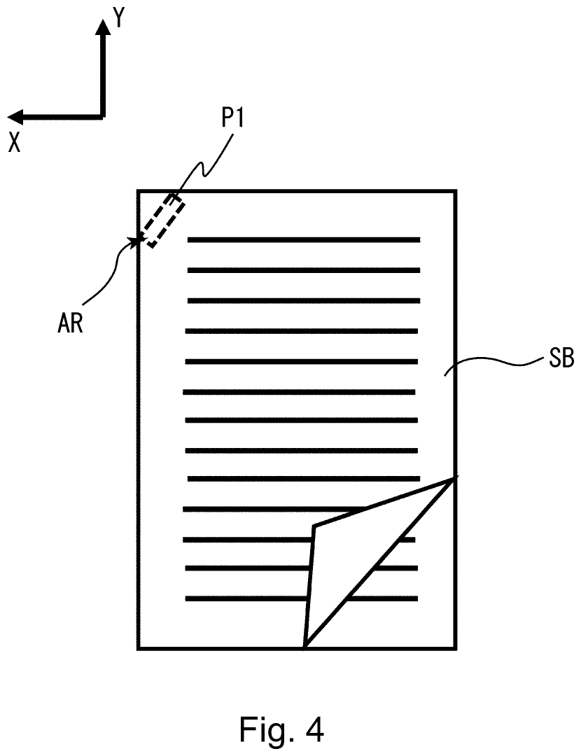

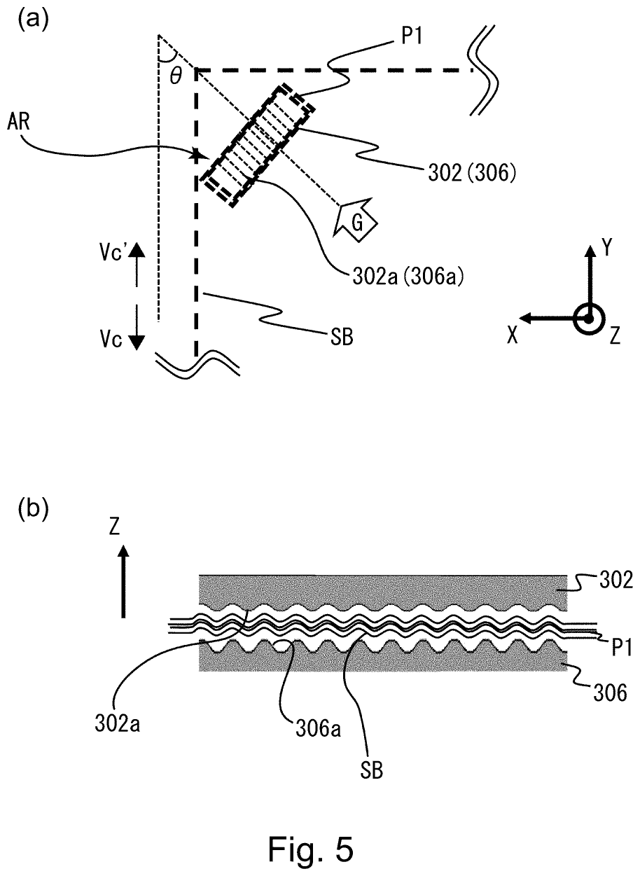

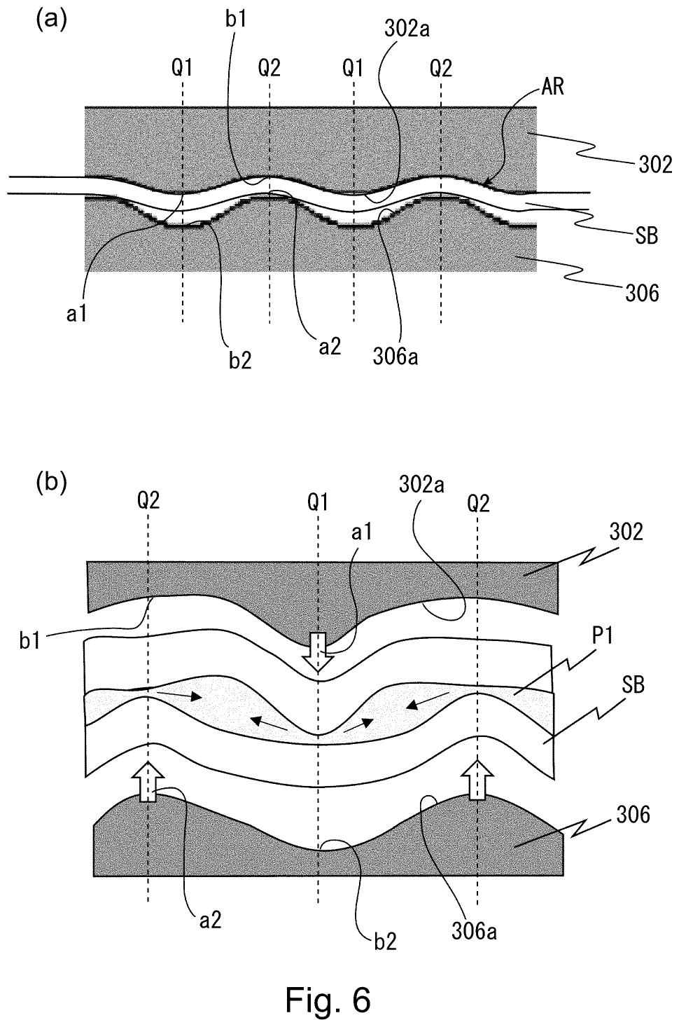

The jogger 206 is a pair of members opposing each other with respect to a sheet width direction perpendicular to a sheet conveying direction Vc (a sheet discharging direction by the discharging roller pair 204). The jogger 206 has a function of supporting a part (a downstream portion of the sheet bundle with respect to the sheet conveying direction Vc) of the sheet bundle supported by the processing stage 211. The aligning roller 207 moves the sheets S, supported by the processing stage 211 and the jogger 206, in a direction opposite to the sheet convey direction Vc. By this, the sheets S are abutted against an aligning wall 208 provided in an end portion of the processing stage 211, so that the sheet bundle is aligned with respect to the sheet conveying direction Vc. The jogger 206 moves a plurality of sheets, aligned by the aligning roller 207, in the sheet width direction and sends the sheets to a predetermined position where processing by the thermocompression bonding portion 203 is performed. The predetermined position is a position such that an adhesive layer P1 (see FIG. 4) described later is discharge immediately below a heating plate 302 of the thermocompression bonding portion 203 described later. Incidentally, during a period in which the sheets S are stacked on the processing stage 211 and are aligned with each other, the processing is performed in a state in which the discharging roller pair 204 is separated from each other. The jogger 206 and the aligning roller 207 are an example of an aligning portion for aligning the sheet bundle stacked on the processing stage 211.

The thermocompression bonding to the sheet bundle is performed by the thermocompression bonding portion 203. In this embodiment, an operation in which single thermocompression bonding is performed every time when sheets in a preset number (for example, four sheets) are stacked on the processing stage 211 is repeated, whereby a booklet including sheets in a larger number (for example, several tens of sheets) can be prepared as a product.

The discharging roller pair 204 is an example of a discharging portion for discharging the sheet bundle to which the processing by the thermocompression bonding portion 203 is completed. When the processing by the thermocompression bonding portion 203 is completed, the discharging roller pair 204 nips a bundle of sheets S (sheet bundle) stacked, aligned, and thermocompression-bonded. The booklet prepared by the thermocompression bonding portion 203 is discharged to an outside of the processing apparatus main body 200B by the discharging roller pair 204. During the discharge, the jogger 206 is retracted from a lower surface of the booklet so that the booklet is dropped onto the discharge tray 205. A timing when the jogger 206 is retracted from the lower surface of the booklet is such that the jogger 206 is retracted in a position where the jogger 206 does not take out a booklet discharged on the discharge tray 205 prior to the associated booklet.

The discharge tray 205 is an example of a discharge stacking portion on which the sheet bundle (booklet) processed by the thermocompression bonding portion 203 is discharged and stacked. The discharge tray 205 is supported by the processing apparatus main body 200B so as to be movable in a vertical (up-down) direction.

### (Thermocompression Bonding Portion)

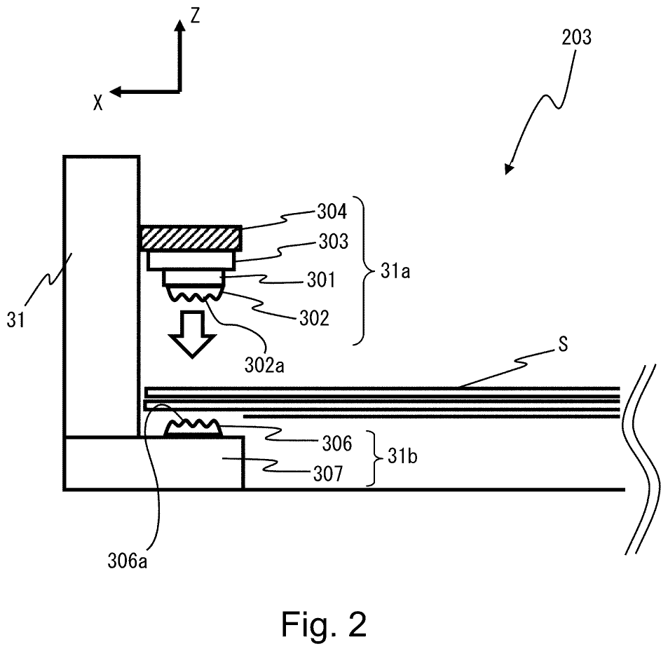

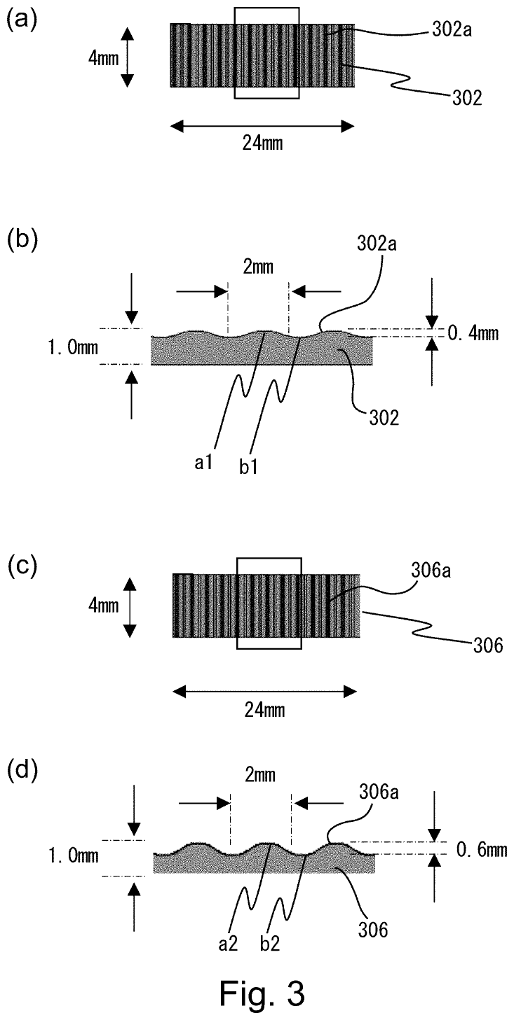

A constitution of the thermocompression bonding portion 203 will be described using FIG. 2. FIG. 2 is a schematic view showing the thermocompression bonding portion 203. As shown in FIG. 2, the thermocompression bonding portion 203 includes a heating unit 31a, a receiving unit 31b, and a holding portion 31. The holding portion 31 holds the heating unit 31a so as to be capable of being raised and lowered in a direction parallel to a Z direction.

In the following description and the drawings, in the thermocompression bonding portion 203, the Z direction is height direction (thickness direction) of the sheet bundle placed on the processing stage 211. Further, directions perpendicular to each other in a vertical flat plane perpendicular to the Z direction are an X direction and a Y direction. The X direction is the sheet width direction of the sheet bundle placed on the processing stage 211, and Y direction is a longitudinal direction (length direction, lengthwise direction) of the sheet bundle. Incidentally, as desired, directions opposite to the X direction, the Y direction, and the Z direction shown in the respective drawings are represented by −X direction, −Y direction, and −Z direction, respectively.

The heating unit 31a includes a raising/lowering lever 304 held by the holding portion 31, and a heater supporting member 303 held by the raising/lowering lever 304 and constituted by a resin material. In addition, the heating unit 31a includes a ceramic heater 301 supported by the heater supporting member 303 and having a thickness of 1.0 mm, and an aluminum-made heating plate 302 provided on the ceramic heater 301 and having an average thickness of 1.0 mm. The heating plate 302 as a first nipping member has a first nipping surface 302a opposing a pressing plate 306 of the receiving unit 31b with respect to the Z direction. The first nipping surface 302a as a first surface includes a plurality of uneven portions (uneven shape) in this embodiment in which the Z direction is a height direction.

The ceramic heater 301 is temperature-controlled to 220° C. which is a target temperature by an unshown temperature detecting portion supported by the heater supporting member 303, and by an unshown electric power applying portion. By this, the first nipping surface 302a of the heating plate 302 on the ceramic heater 301 is temperature-controlled to 200° C. Incidentally, instead of the ceramic heater 301, another heat generating member may also be provided. For example, as the heat generating member, a halogen lamp or a heater substrate including the heat generating resistor may also be used.

The receiving unit 31b is fixed to the holding portion 31, and includes a supporting member 307 constituted by a resin material and includes the pressing plate 306 which is supported by the supporting member 307, which has an average thickness of 1.0 mm, and which is made of aluminum. The pressing plate 306 as a second nipping member has a second nipping surface 306a opposing the first nipping surface 302a of the heating plate 302. A second nipping surface 306a as a second surface includes a plurality of uneven portions (second plurality of uneven portions) engageable with a plurality of uneven portions (first plurality of uneven portions) of the first nipping surface 302a.

The first nipping surface 302a of the heating plate 302 is capable of nipping a plurality of sheets S between itself and the second nipping surface 306a of the pressing plate 306 by movement of the raising/lowering lever 304, driven by an unshown driving source, relative to the holding portion 31 in −Z direction. The sheet bundle constituted by the plurality of sheets S is pressed at average surface pressure of 0.2 to 8.0 MPa by the heating plate 302 and the pressing plate 306. Incidentally, the raising/lowering lever 304 includes, for example, a rack portion and is constituted so as to be capable of being raised and lowered by engaging a pinion gear, fixed to an output shaft of an unshown motor, with the rack portion and by driving the motor.

Further, in order to suppress surface contamination of the sheet bundle, the first nipping surface 302a and the second nipping surface 306a may include a parting layer such as PTFE (polytetrafluoroethylene) coating. Further, in this embodiment, the heating plate 302 and the pressing plate 306 are constituted by aluminum, and the heater supporting member 303 and the supporting member 307 are constituted by the resin material, but these plates and members are not limited thereto. Each of the heating plate 302, the pressing plate 306, the heater supporting member 303, and the supporting member 307 may also be constituted by a desired material.

Part (a) of FIG. 3 is a front surface showing the first nipping surface 302a of the heating plate 302, and part (b) of FIG. 3 is a side view showing the first nipping surface 302a of the heating plate 302. Part (c) of FIG. 3 is a front view of the second nipping surface 306a of the pressing plate 306, and part (d) of FIG. 3 is a side view of the second nipping surface 306a of the pressing plate 306.

As shown in parts (a) and (b) of FIG. 3, the heating plate 302 is formed by pressing so that a mountain shape of 0.4 mm in height and 2.0 mm in width is formed on an aluminum plate of 4 mm (length)×24 mm (width)×1 mm (TN) in 11 positions with a pitch of 2.0 mm. By this, on the first nipping surface 302a of the heating plate 302, a plurality of uneven portions each having a height of 0.4 mm from a lowest point of a recessed portion to a highest point of projected portion are formed, and an interval of two adjacent projected portions is 2.0 mm.

Further, as shown in parts (c) and (d) of FIG. 3, the pressing plate 306 is formed by pressing so that a mountain shape of 0.6 mm in height and 2.0 mm in width is formed on an aluminum plate of 4 mm (length)×24 mm (width)×1 mm (TN) in 11 positions with a pitch of 2.0 mm. By this, on the second nipping surface 306a of the pressing plate 306, a plurality of uneven portions each having a height of 0.6 mm from a lowest point of a recessed portion to a highest point of projected portion are formed, and an interval of two adjacent projected portions is 2.0 mm. That is, a height difference between each recessed portion and each projected portion of the plurality of uneven portions formed on the first nipping surface 302a is 0.4 mm, whereas a height difference between each recessed portion and each projected portion of the plurality of uneven portions formed on the second nipping surface 306a is 0.6 mm, so that these height differences are different from each other.

Uneven shapes (plurality of uneven portions) of these first nipping surface 302a and second nipping surface 306a are formed by a plurality of grooves parallel to a predetermined direction (sheet bundle opening direction G described later in this embodiment) and are a so-called “parallel” shape. The predetermined direction may be any direction when the predetermined direction is a direction along a surface of the sheet bundle placed on the processing stage 211. Incidentally, the uneven shapes (plurality of uneven portions) of the first nipping surface 302a and the second nipping surface 306a may also be formed by knurling in which grooves are cut by using a milling machine of a vertical type or a horizontal type. That is, a processing method of the plurality of grooves which are formed on the first nipping surface 302a and the second nipping surface 306a and which are parallel to the predetermined direction are not limited to the processing but may also be cutting or the like.

Incidentally, a size of each of the heating plate 302 and the pressing plate 306 is set depending on a size of a portion (bonding region) where the sheet bundle is bonded, and in the case where a corner of the sheet bundle is bond, from viewpoints of a quality and an operating property, a range of 1.0 mm to 8.0 mm in length and 8.0 mm to 50.0 mm in width is performed. When the bonding region is excessively small, a desired adhesive (bonding) force cannot be obtained, and when the bonding region is excessively large, an operating property during operating (spread) of the bonded sheet bundle, or the like is measured.

A shape, a height, a width, and a pitch of the uneven portions formed on each of the first nipping surface 302a and the second nipping surface 306a may only be required to basically impart the uneven shape to the sheet S, and it is preferable that the height is in a range of 0.1 mm to 1 mm and that the width of each projected portion and the pitch are in a range of 0.5 mm to 7 mm. When the height of each uneven portion is excessively low, the sheet S is not readily deformed (to which the uneven portions are not readily imparted), and when the height of each uneven portion is excessively high, it is not preferable that there is a case where the quality becomes poor due to breakage of the sheet S. Similarly, when the pitch of the uneven portions is excessively small, the sheet S is not readily deformed, and when the pitch is excessively large, an effect of imparting the uneven portions becomes small.

Incidentally, a shape of each of a projected portion a1 and a recessed portion b1 of the first nipping surface 302a may preferably be an R shape (0.5 to φ30) in consideration of a close contact property of the sheet, breakage of the sheet, and the like. Similarly, a shape of each of a projected portion a2 and a recessed portion b2 of the second nipping surface 306a may preferably be an R shape (φ0.5 to φ30). Further, the projected portions a1 and a2 and the recessed portions b1 and b2 may preferably have the roller shapes to the same degree so that the projected portion and the recessed portion of the first nipping surface 302a and the recessed portion and the projected portion of the second nipping surface 306a engage with each other, respectively.

FIG. 4 is a schematic view showing an arrangement of the adhesive (bonding) layer P1 formed on the sheet S. The adhesive layer (toner image for bonding) P1 for bonding the sheets together is formed in an adhesive (bonding) region (pasting margin) in which the sheets are bonded together. As shown in FIG. 4, in the sheet processing apparatus 200 in this embodiment, it is possible to perform corner binding in which a corner of the sheet bundle is bonded, and the adhesive region is also set to the corner. A position, a shape, a size, and the like of the adhesive layer P1 is capable of being changed in conformity of specifications of the sheet processing apparatus 200.

Incidentally, in the case where the image forming apparatus 1 prepares a booklet through one-side printing, the adhesive layer is formed only on one surface of the sheet S (which surface is the same surface as the toner image for recording). In the case of a booklet prepared through double-side printing, the adhesive layer may also be formed only on one surface of the sheet S or on both surfaces of the sheet S.

The adhesive layer P1 formed in the corner of the sheet S is heated and pressed by being nipped between the first nipping surface 302a of the heating plate 302 and the second nipping surface 306a of the pressing plate 306, and thus the sheets S are bonded together, so that the sheet bundle is formed. At this time, a region of the sheet bundle SB in which the sheets S are bonded together by the adhesive layer P1 as the toner image is referred to as an adhesive region AR. That is, the adhesive layer P1 can be said to be formed in the adhesive region AR of the sheet bundle SB.

Part (a) of FIG. 5 is a schematic view of the heating plate 302 and the pressing plate 306 as viewed in the Z direction, and part (b) of FIG. 5 is a sectional view showing the sheet bundle SB pressed by the heating plate 302 and the pressing plate 306. As shown in part (a) of FIG. 5, the heating plate 302 and the pressing plate 306 are disposed so as to oppose each other in the Z direction so that the first nipping surface 302a and the second nipping surface 306a engage with each other. Incidentally, in part (a) of FIG. 5, a principal opening direction of the booklet (sheet bundle SB) prepared in this embodiment is denoted as an opening direction G. The opening direction G is an angle thereof inclined by an angle θ with respect to a direction Vc′ opposite to the sheet conveying direction Vc, and in this embodiment, the angle θ is 45°. At this time, the plurality of grooves formed on the first nipping surface 302a of the heating plate 302 and the plurality of grooves formed on the second nipping surface 306a of the pressing plate 306 extend parallel to the opening direction G. Further, these plurality of grooves are arranged in a perpendicular direction perpendicular to the opening direction G, and a length of each of the grooves arranged in the perpendicular direction is substantially the same. Further, the heating plate 302 and the pressing plate 306 are disposed in positions corresponding to the adhesive layer P1 formed in the corner of the sheets S, i.e., positions corresponding to the adhesive region AR. As shown in part (b) of FIG. 5, the sheet bundle SB is deformed in the adhesive region AR by being nipped by the first nipping surface 302a of the heating plate 302 and the second nipping surface 306a of the pressing plate 306, so that a wavy uneven shape is formed (imparted). At the same time, the adhesive layer P1 is heated and pressed in the adhesive region AR, so that the sheet bundle SB is bonded in the adhesive region AR.

For example, in the case where sheets rough in surface property (low in surface smoothness) are bonded together, a close contact property between the sheets is low, and therefore, desired adhesive strength cannot be obtained only by bonding with the adhesive layer P1 in some cases. However, the sheet bundle SB is bonded by the adhesive layer P1 in the adhesive region AR, and in addition, the uneven shape is formed on the sheet bundle SB, so that the adhesive strength of the sheet bundle SB can be improved.

### (Effect 1: Effect by Increase in Thickness of Adhesive Layer)

An effect by imparting the uneven shape to the sheet bundle SB will be specifically described. A first effect is an effect by an increase in thickness of the adhesive layer. Part (a) of FIG. 6 is a sectional view showing the sheet bundle SB pressed by the first nipping surface 302a and the second nipping surface 306a, and part (b) of FIG. 6 is a sectional view showing the sheet bundle SB and the adhesive layer P1 which are pressed. Incidentally, in part (b) of FIG. 6, for explanation, only one adhesive layer P1 is shown.

As shown in part (a) of FIG. 6, the projected portion a1 and the recessed portion b1 of the first nipping surface 302a of the heating plate 302 and the recessed portion b2 and the projected portion a2 of the second nipping surface 306a of the pressing plate 306 engage with each other, respectively, so that the sheet bundle SB is deformed in a wavy shape between the first nipping surface 302a and the second nipping surface 306a. At this time, the sheet bundle SB is pressed at high pressure in a portion Q1 where the projected portion a1 and the recessed portion b2 engage with each other and a portion θ2 where the recessed portion b1 and the projected portion a2 engage with each other, and is pressed at low pressure in a portion between the portion Q1 and the portion Q2 compared with the pressure in the portions Q1 and Q2. That is, in the adhesive region AR, the sheet bundle SB has a pressure distribution including the high pressure and the low pressure.

As shown in part (b) of FIG. 6, the adhesive layer P1 which is an adhesive layer is collected by being pushed out to a low-pressure portion when the adhesive layer P1 is heated and pressed by the first nipping surface 302a and the second nipping surface 306a, so that a layer thickness thereof varies depending on a place. That is, the layer thickness of the adhesive layer P1 in the portion between the portion Q1 and the portion Q2 of the sheet bundle SB becomes thick.

In general, plain paper used as the sheet S comprises pulp fibers formed in a mesh shape and has undulation of several millimeter pitch and a gap of about 10 to 20 μm in depth. The adhesive layer P1 flows due to melting and deformation by heating and pressing during the bonding and is moved into the gap of the sheet S and the like, and therefore, when the thickness of the adhesive layer P1 is thin, it becomes difficult to ensure an adhesive surface contributing to the bonding, so that contact unevenness occurs and thus the adhesive force lowers. For this reason, in order to obtain a stable and strong adhesive force, it is preferable that the influence of the gap causing the contact unevenness is alleviated by setting the adhesive layer P1 so as to become thick.

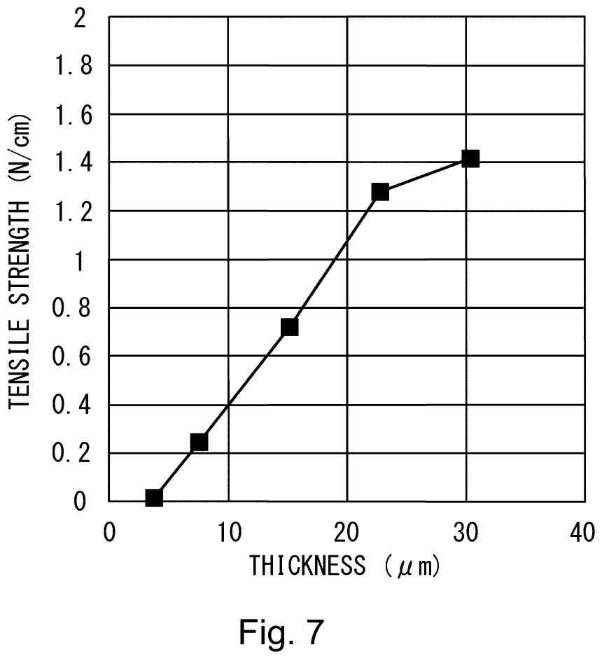

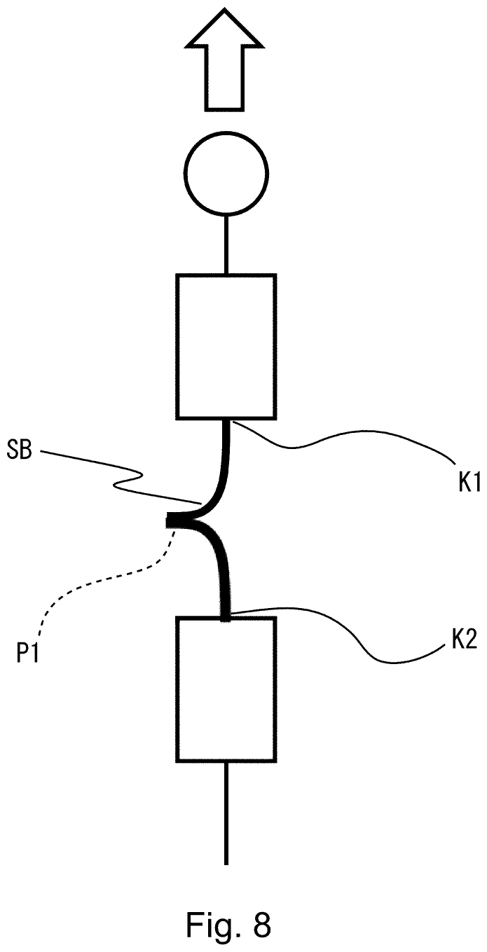

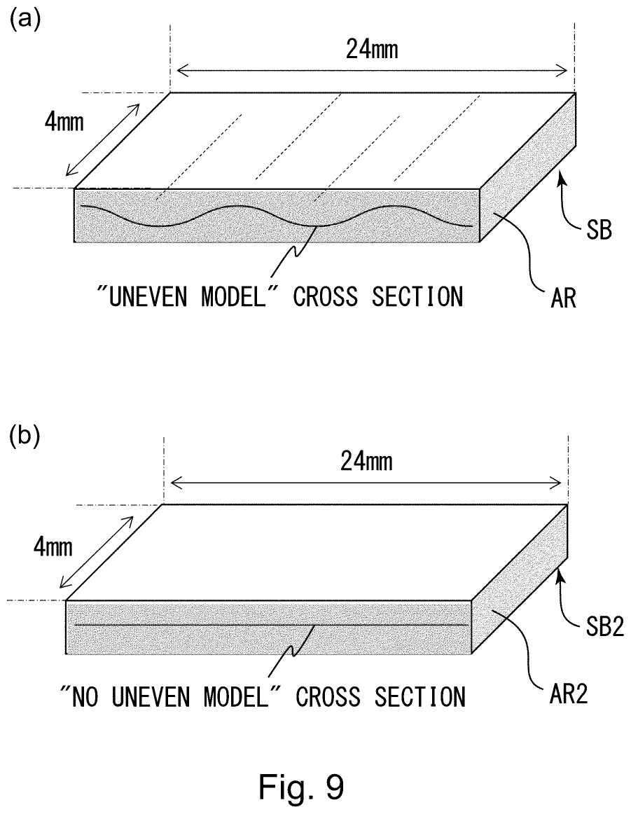

FIG. 7 is a graph showing a relationship of tensile strength of the sheet bundle SB relative to the thickness of the adhesive layer P1. In this embodiment, the tensile strength of the sheet bundle SB is measured in the following method for a test sample consisting of two plain paper sheets each having a predetermined width (10 mm width). A test sample P is subjected to a tensile test in which as shown in FIG. 8, at a room temperature (23° C.), paper ends K1 and K2 of the two plain paper sheets are pulled at a tension speed of 50 mm/min by a testing machine (“TENSILON Universal Testing Machine RTG-1225”, manufactured by A&D Company, Ltd.). A maximum tensile force in a gradient of an initial rising portion of a tension-distortion curve obtained by the tensile test was compared while changing the thickness of the adhesive layer P1.

As is understood from FIG. 7, the tensile strength is changed on the basis of the thickness of the adhesive layer P1, and there is a tendency that the tensile strength becomes larger with a larger thickness of the adhesive layer P1. Incidentally, it is understood that the adhesive layer P1 may only be required to have a thickness of about 20 μm because adhesive strength required for the sheet bundle SB can be obtained when tensile strength of not less than a reference value of 1.0 N/cm can be obtained.

In this embodiment, the uneven shape is imparted to the sheet bundle SB, and in addition, in the adhesive region AR, the sheet bundle SB is pressed with a pressure distribution including the high pressure and the low pressure, and therefore, the thickness of the adhesive layer P1 heated and pressed does not become constant. That is, it is possible to form a portion where the thickness of the adhesive layer P1 is partially thick. Further, a good contact portion is ensured in the thick portion of the adhesive layer P1, so that desired adhesive strength can be obtained. Accordingly, even when a toner amount used for the adhesive layer P1 is set to a small toner amount, desired adhesive strength can be obtained, and therefore, it becomes possible to suppress a toner consumption amount to a low level.

### (Effect 2: Effect by Increase in Rigidity of Sheet Bundle)

A second effect by imparting the uneven shape to the sheet bundle SB is an effect by an increase in rigidity of the sheet bundle SB, so that stress exerted on the adhesive layer P1 during tension can be suppressed to a low level.

In order to confirm a change in rigidity due to the shape of the sheet bundle SB in this embodiment, geometrical moment of inertia of the sheet bundle SB was calculated by a structural analyzing tool. The geometrical moment of inertia is an index indicating non-flexibility of an article determined by a cross-sectional shape, and is defined by (cross-sectional area)×(distance from flexural center)² in general, and a larger value thereof slows that the article is not readily bent.

Analysis of the geometrical moment of inertia of the sheet bundle was obtained by assuming paper of 80 g/m² in basis weight and from a relationship bending moment of cantilever [M=PL] and a bending stress expression (σ=M/Iz·e]. Incidentally, M is bending stress, P is load, L is a length of cantilever, σ is stress. Iz is geometrical moment of inertia, and e is a distance from a bending center. Part (a) of FIG. 9 shows a cross section of n “uneven model” in which unevenness of an adhesive region AR of a (length: 4 mm)×(width: 24 mm) in a sheet bundle SB in this embodiment is modeled. Part (b) of FIG. 9 shows a cross section of a “no uneven model” in which an adhesive region AR2, having no uneven, of a sheet bundle SB2 in a comparison example is modeled. For each of these “uneven model” and “no uneven model”, the geometric moment of inertia was obtained.

The geometric moment of inertia of the “no uneven model” shown in part (b) of FIG. 9 is 4.17E−04 (mm⁴), and the geometric moment of inertia is 4.52E−03 (mm⁴). That it, it was found that the geometric moment of inertia is increased by imparting the uneven shape to the sheet bundle. Accordingly, it is understood that compared with the sheet bundle SB2 to which the uneven shape is not imparted, the sheet bundle SB to which the uneven shape is imparted becomes hard to be bent.

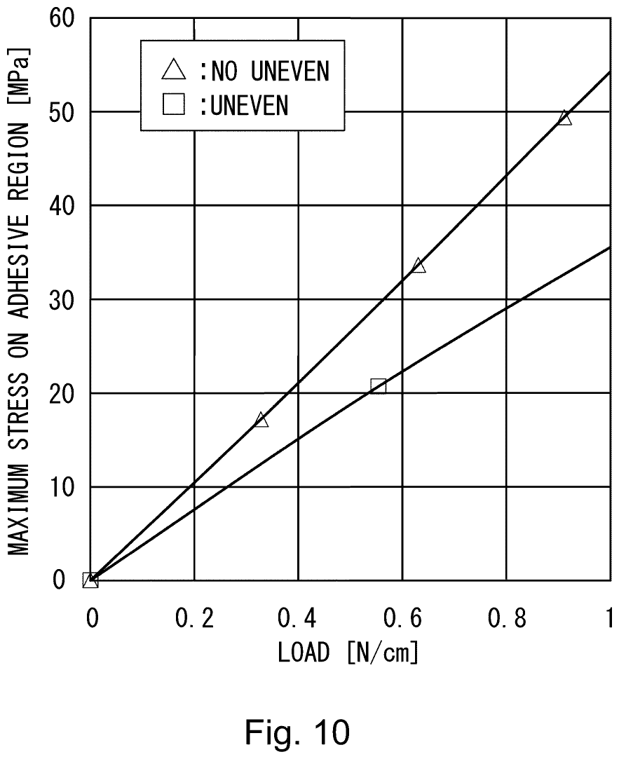

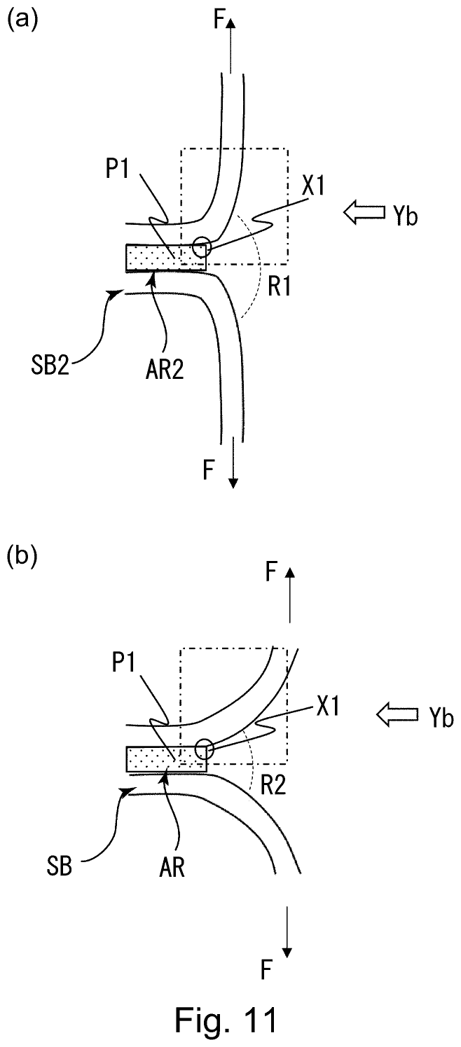

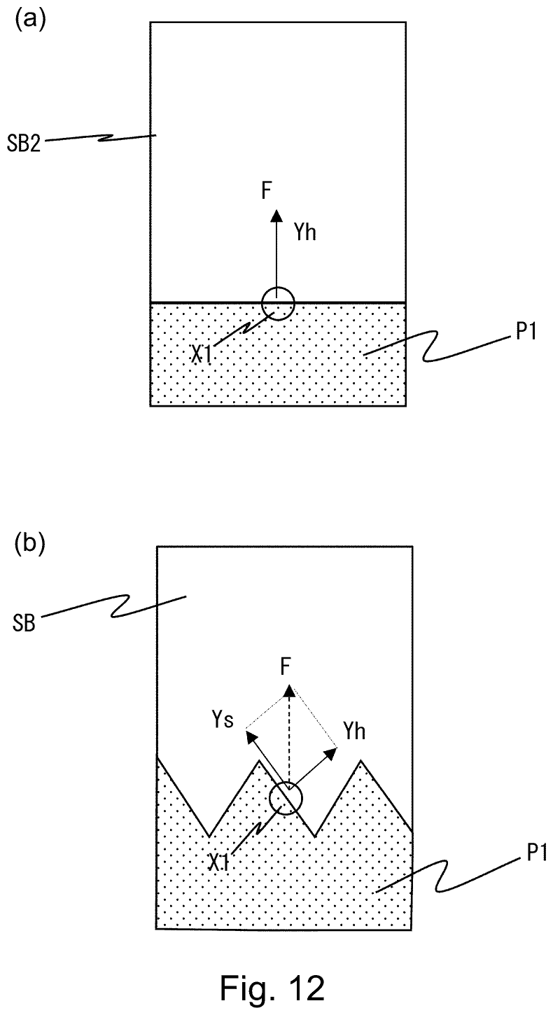

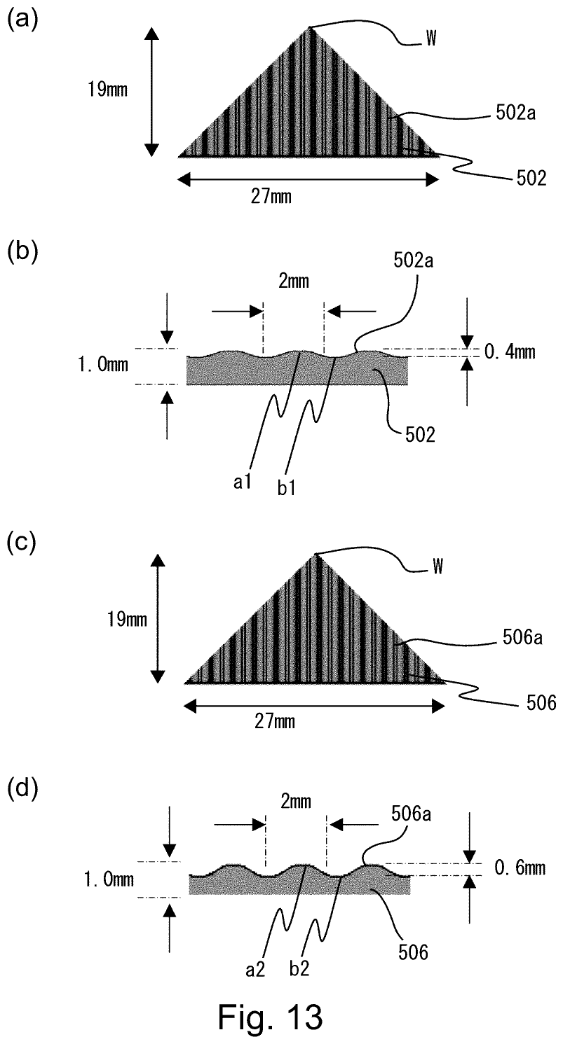

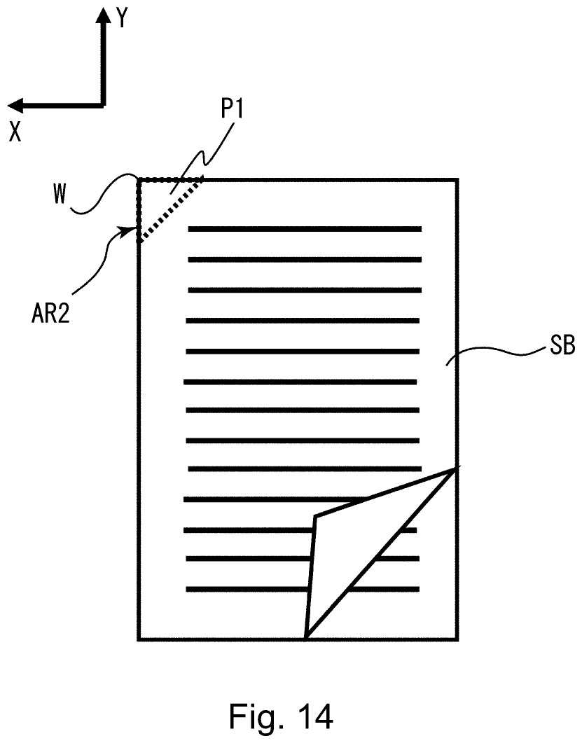

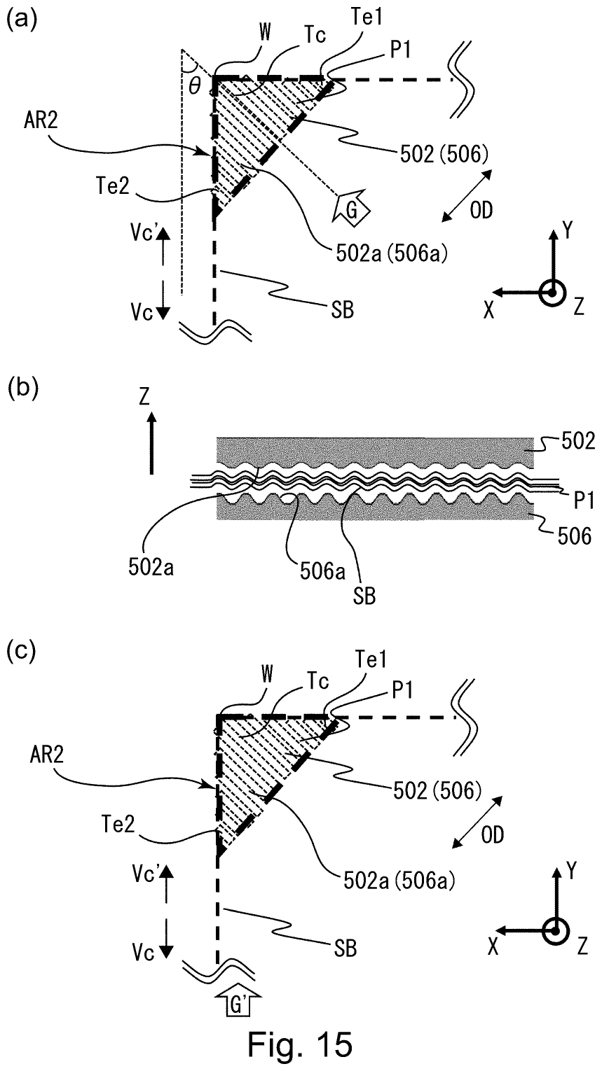

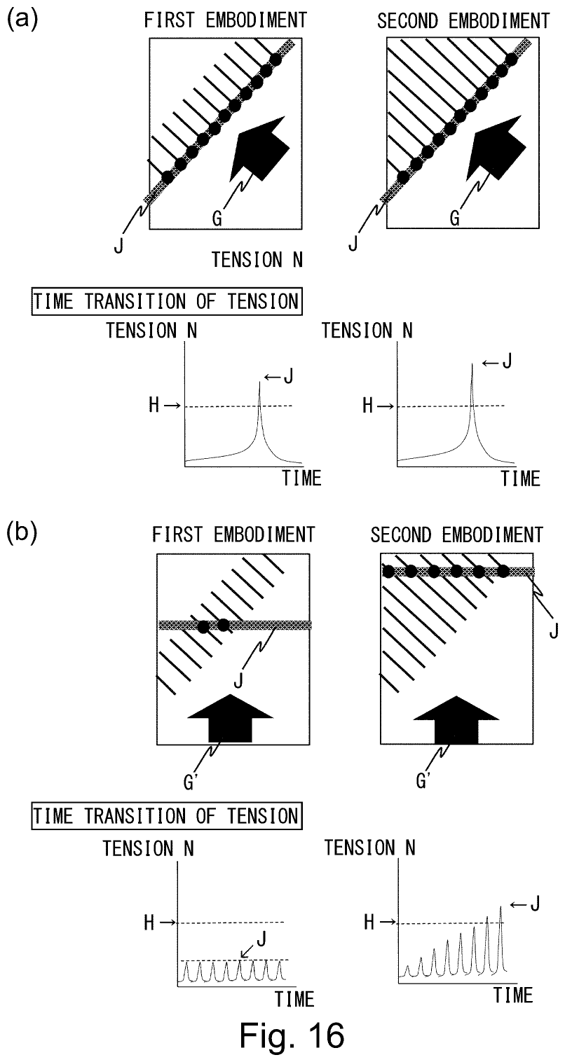

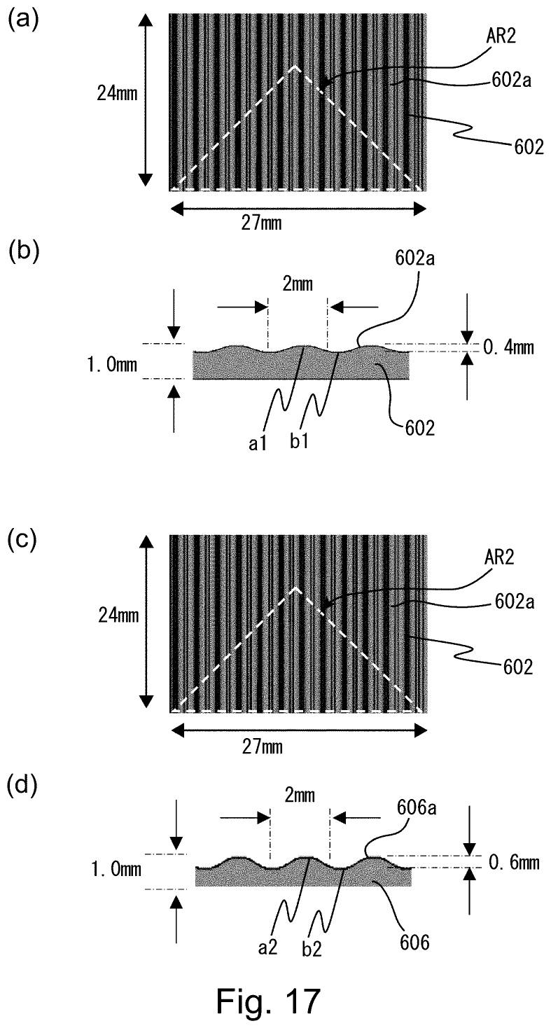

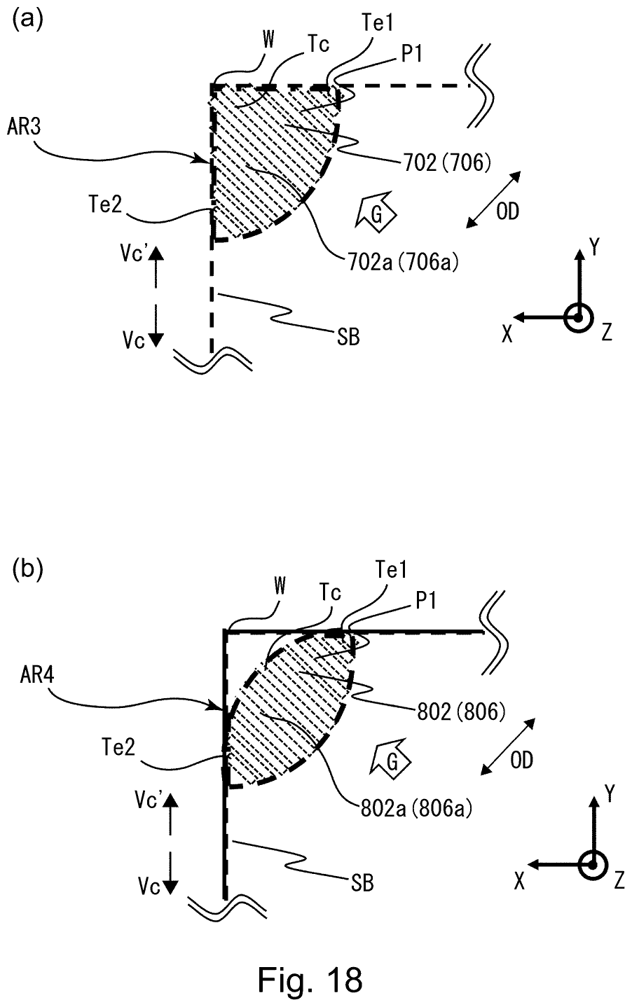

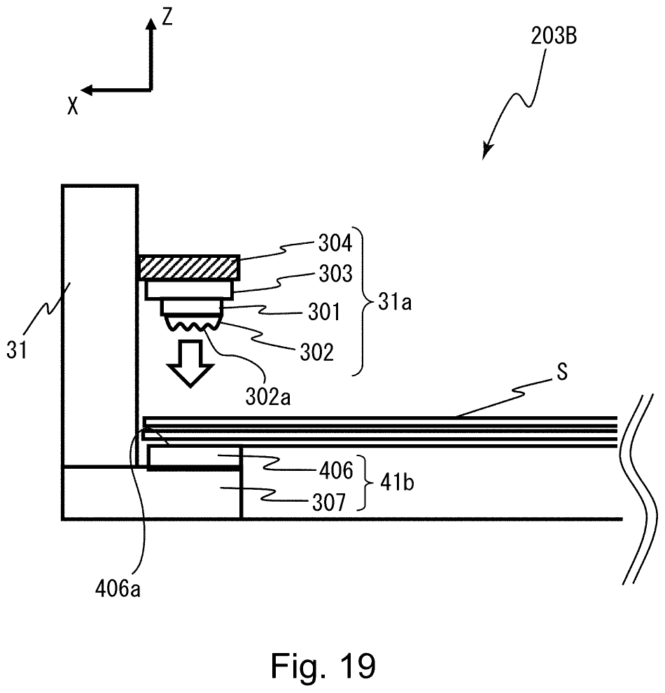

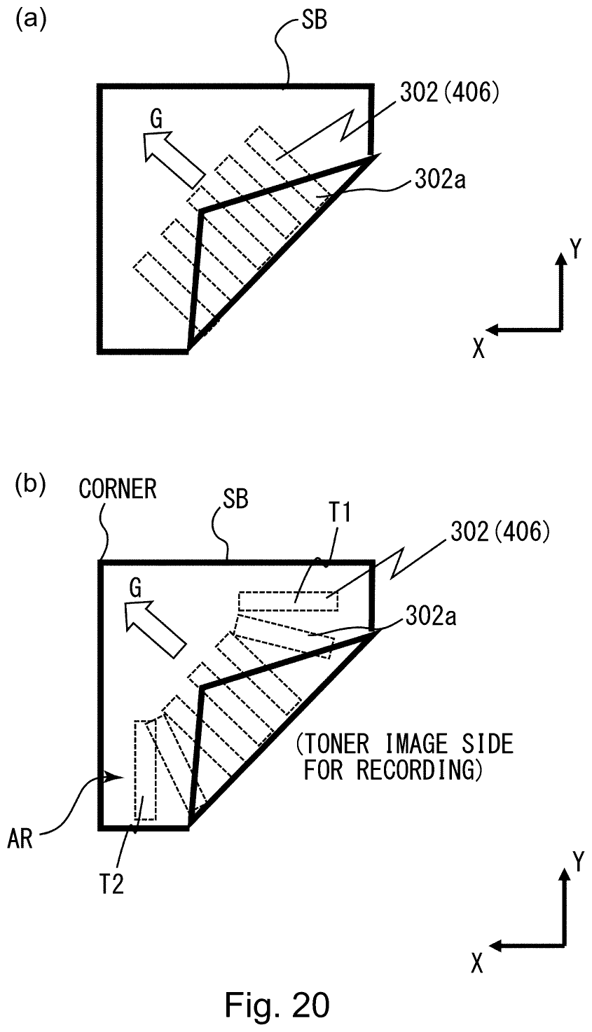

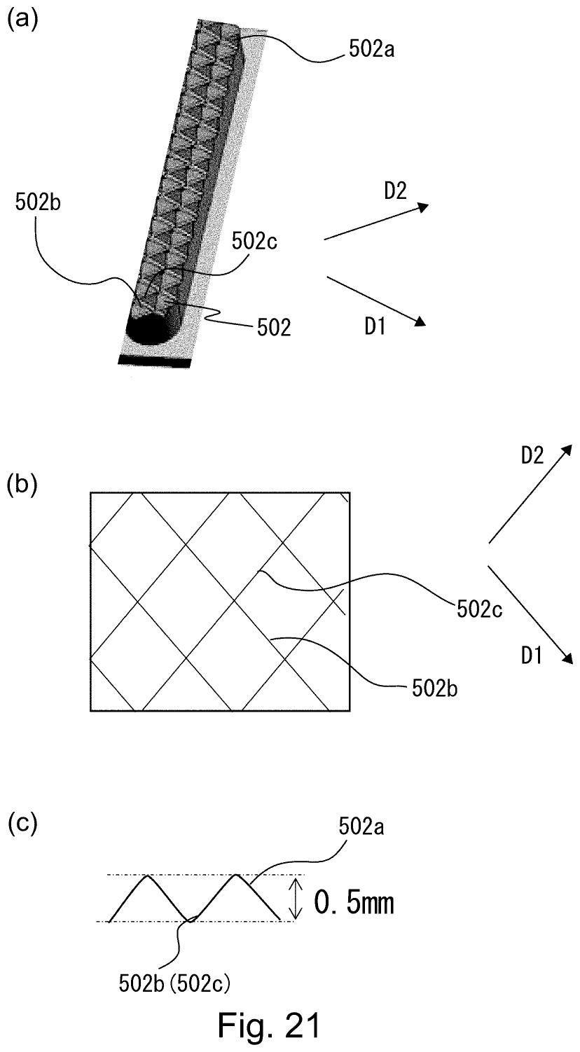

FIG. 10 is a graph showing a simulation result of analysis of maximum stress exerted on the adhesive region AR where a load in a tensile direction such that the load is applied, by the tensile testing machine shown in FIG. 8, to the sheet bundle prepared in each of the “uneven model” and the “no uneven model”. As shown in FIG. 10, with an increasing load applied to the sheet bundle, the maximum stress exerted on the adhesive region becomes larger. Further, in the case of the “uneven model”, compared with the “no uneven model”, even when the same load is applied, the maximum stress exerted on the adhesive region is small. This is because the geometric moment of inertia of the sheet bundle SB is increased by the uneven shape imparted to the sheet bundle SB by the first nipping surface 302a and the second nipping surface 306a, and the sheet bundle SB becomes hard to be bent and thus deformation of the sheet bundle SB in the tensile direction is suppressed. As a result, the maximum stress exerted on the adhesive region AR also becomes small, so that the adhesive region AR of the sheet bundle SB becomes capable of withstanding even for a larger load.

Part (a) of FIG. 11 shows a state when the sheet bundle SB2 of the “no uneven model” shown in part (b) of FIG. 9 is pulled in arrow directions by a tensile force F, and part (b) of FIG. 11 shows a state when the sheet bundle SB of the “uneven model” shown in part (a) of FIG. 9 is pulled in the arrow directions by the tensile force F. As shown in part (a) of FIG. 11, the sheet bundle SB2 of the “no uneven model” is large in opening angle R1 of two sheets, and therefore, stress exerted on a point X1 of the adhesive layer P1 in the adhesive region AR2 becomes large. As shown in part (b) of FIG. 11, in the sheet bundle SB of the “uneven model” as in this embodiment, an opening angle R2 of two sheets is smaller than the opening angle R1 of the sheet bundle SB2 of the “no uneven model”. For this reason, the stress exerted on the point X1 of the adhesive layer P1 in the adhesive region AR can be suppressed to a low level, so that the adhesive strength of the sheet bundle SB can be improved.

As a second effect by imparting the uneven shape to the sheet bundle SB, a peeling direction component of the stress exerted on the point X1 of the adhesive layer P1 can be suppressed to be small. Part (a) of FIG. 12 is a schematic view of a portion enclosed by a chin line as viewed in an arrow Yb direction in part (a) of FIG. 11, and part (b) of FIG. 12 is a schematic view of a portion enclosed by a chain line as viewed in an arrow Yb direction in part (b) of FIG. 11. That is, part (a) of FIG. 12 shows a cross section of the sheet bundle SB2 in the comparison example, and part (b) of FIG. 12 shows a cross section of the sheet bundle SB in this embodiment.

As shown in part (a) of FIG. 12, for the sheet bundle SB2 in the comparison example, the uneven shape is not imparted to the adhesive region, and therefore, in the point X1 of the adhesive layer P1, stress is imparted in the peeling direction (arrow Yh direction) by the tensile force F. As shown in part (b) of FIG. 12, for the sheet bundle SB in this embodiment, the uneven shape is imparted to the adhesive processing, and therefore, the tensile force F is dispersed in the peeling direction (arrow Yh direction) and a shearing direction (arrow Ys direction) in the point X1 of the adhesive layer P1, so that the stress in the peeling direction is alleviated. As a result, even when a stronger tensile force F is exerted on the sheet bundle SB, the sheet bundle SB is capable of obtaining desired adhesive strength.

Incidentally, in this embodiment, as described above with reference to parts (b) and (d) of FIG. 3, the height of the plurality of uneven portions of the first nipping surface 302a of the heating plate 302 is constituted so as to be lower than the height of the plurality of uneven portions of the second nipping surface 306a of the pressing plate 306. For this reason, the sheet bundle SB is heated without being separated from the first nipping surface 302a in a state in which the sheet bundle SB is deformed in a shape along the first nipping surface 302a by being pressed by the first nipping surface 302a of the heating plate 302. As a result, heat of the heating plate 302 can be efficiently transmitted to the sheet bundle SB, so that it is possible to reduce a target temperature of the heating plate 302 and to shorten a time in which the heating plate 302 presses the sheet bundle SB. Therefore, productivity and a heat-resistant property of the thermocompression bonding portion 203 can be improved, and in addition, a lifetime of the thermocompression bonding portion 203 can be prolonged.

### (Measurement of Adhesive Strength by Tensile Testing Machine)

As confirmation of an effect of the present disclosure, a result such that a sheet bundle was prepared using the thermocompression bonding portion 203 and was subjected to the tensile test is shown. Further, as the comparison example, a result such that a sheet bundle prepared by the heating plate 302 with no uneven portion and the pressing plate 306 with no uneven portion was subjected to the tensile test is also shown.

Further, as the adhesive layer, a plurality of samples different in thickness were used, and as a sheet kind, rough paper and smooth paper were used, and then a difference in adhesive strength of each sheet bundle was checked. The thickness of the adhesive layer formed in each sheet bundle includes two kinds of 10 μm and 20 μm. The rough paper used is “Neenah Capitol Bond 25% Cotton Paper” manufactured by Neenah Paper, Inc. The smooth paper used is high white paper (“GF-C081”, manufactured by Canon Marketing Japan Inc.).

The tensile test as confirmation of the adhesive strength was conducted by measuring the adhesive strength of each sheet bundle by using the testing machine (“TENSILON Universal Testing Machine RTG-1225”, manufactured by A&D Company, Ltd.) similarly as shown in FIG. 8. For measurement of the adhesive strength, as shown in FIG. 8, a test sample P of two sheets (sheet bundle) having a predetermined width (10 mm width) was prepared, and in a tension-torsion curve obtained under a condition of a room temperature (23° C.) and a test speed of 50 mm/min, a maximum tensile force in a gradient of an initial rising portion was compared and evaluated, and was regarded as the adhesive strength. Evaluation was performed by preparing five test samples (1) to (5) and then by comparing maximum tensile forces thereof with each other. Incidentally, in the tensile test, when the tensile force per unit length is a reference value of 1.0 N/cm or more, discrimination that sufficient adhesive strength is obtained was made.

A table 1 below is a result of measurement of the adhesive strength by the tensile testing machine in this embodiment.

TABLE 1
TENSILE FORCE (N/cm)

| | FIRST EMBODIMENT | | | COMPARISON EXAMPLE | | |
|---|---|---|---|---|---|---|
| | ALT*¹ | | | | | |
| | 10 μm | 20 μm | 20 μm | 10 μm | 20 μm | 20 μm |
| | PAPER*² | | | | | |
| | SP | SP | RP | SP | SP | RP |
| AVERAGE | 1.34 | 2.86 | 1.54 | 0.46 | 1.20 | 0.58 |
| SAMPLE (1) | 1.5 | 2.8 | 1.7 | 0.2 | 1.5 | 0.7 |
| SAMPLE (2) | 1.2 | 3.1 | 1.4 | 0.5 | 1.1 | 0.5 |
| SAMPLE (3) | 1.3 | 2.7 | 1.5 | 0.4 | 1.3 | 0.6 |
| SAMPLE (4) | 1.4 | 2.8 | 1.6 | 0.9 | 1.0 | 0.5 |
| SAMPLE (5) | 1.3 | 2.9 | 1.5 | 0.3 | 1.1 | 0.6 |

*¹“ALT” is the adhesive layer thickness.
*²“PAPER” is a kind of the paper. “SP” is the smooth paper, and “RP” is the rough paper.

As shown in the above table 1, in the comparison example, in the case where the thickness of the adhesive layer is 10 μm and the case of the rough paper, the tensile force becomes 1.0 N/cm or less, so that a sufficient adhesive force cannot be ensured. On the other hand, in the case of this embodiment (first embodiment), even the case where the thickness of the adhesive layer is 10 μm and in the case of the rough paper, the tensile force becomes 1.0 N/cm or more, so that the sufficient adhesive force was obtained. Further, in this embodiment, a variation in the respective samples is also suppressed, so that a stable adhesive force is obtained.

As described above, in this embodiment, each of the first nipping surface 302a and the second nipping surface 306a was provided with the plurality of uneven portions engaging with the plurality of associated uneven portions, respectively, and the adhesive region AR of the sheet bundle SB was pressed by the first nipping surface 302a and the second nipping surface 306a. By this, the sheet bundle SB was bonded in the adhesive layer P1 in the adhesive region AR, and in addition, the uneven shape was formed on the sheet bundle SB in the adhesive region AR. For this reason, a close contact property between the sheets is ensured, and in addition, the geometric moment of inertia of the sheet bundle can be increased, and therefore, rigidity of the sheet bundle toward the opening direction G is improved, so that the adhesive strength (tensile strength) of the sheet bundle SB can be improved.

Further, in the adhesive region AR, the first nipping surface 302a and the second nipping surface 306a press the sheet bundle SB with the pressure distribution including the high pressure and the low pressure, and therefore, a portion where the thickness of the adhesive layer P1 is locally thick can be formed. Therefore, the toner consumption amount can be reduced, and in addition, the adhesive strength of the sheet bundle SB can be improved.

### Second Embodiment

Next, a second embodiment of the present disclosure will be described, but in the second embodiment, the shapes of the heating plate 302 and the pressing plate 306 in the first embodiment are changed. For this reason, constitutions similar to those in the first embodiment will be omitted from illustration or will be described by adding, thereto in the drawings, the same reference numerals or symbols.

Part (a) of FIG. 13 is a front surface showing a first nipping surface 502a of a heating plate 502 in this embodiment, and part (b) of FIG. 13 is a side view showing the first nipping surface 502a of the heating plate 502. Part (c) of FIG. 13 is a front view of a second nipping surface 506a of a pressing plate 506, and part (d) of FIG. 13 is a side view of the second nipping surface 506a of the pressing plate 506.

As shown in parts (a) and (b) of FIG. 13, a thermocompression bonding portion in this embodiment includes the heating plate 502 and the pressing plate 506. Each of the heating plate 502 and the pressing plate 506 has a right-angle vertex W and includes a cross section having a substantially right triangle shape, and has a length of 19 mm, a width of 27 mm, and a thickness of 1 mm. A pitch and a height of a mountain shape of each of the first nipping surface 502a of the heating plate 502 and the second nipping surface 506a of the pressing plate 506 are similar to those in the first embodiment.

FIG. 14 is a schematic view showing an arrangement of the adhesive layer P1 formed on a sheet bundle SB in this embodiment. The adhesive layer (toner image for bonding) P1 for bonding the sheets together is formed in an adhesive region AR2 (pasting margin) in which the sheets are bonded together. As shown in FIG. 4, in the sheet processing apparatus in this embodiment, it is possible to perform corner binding in which a corner of the sheet bundle SB is bonded, and a triangular adhesive region ARZ is set to the corner of the sheet bundle SB.

Part (a) of FIG. 15 is a schematic view of the heating plate 502 and the pressing plate 506 in this embodiment as viewed in the Z direction, and part (b) of FIG. 15 is a sectional view showing the sheet bundle SB pressed by the heating plate 502 and the pressing plate 506 in this embodiment. As shown in part (a) of FIG. 15, the heating plate 502 and the pressing plate 506 are disposed so as to oppose each other in the Z direction so that the first nipping surface 502a and the second nipping surface 506a engage with each other.

Incidentally, the shape of the adhesive region AR2 in this embodiment is changed from the shape by the above-described heating plate 502 and pressing plate 506 to the triangular shape, and the right-angle vertex W is disposed correspondingly to the corner of the sheet bundle SB. Further, a plurality of grooves formed on the first nipping surface 502a of the heating plate 502 and a plurality of grooves formed on the second nipping surface 506a of the pressing plate 506 extend parallel to the opening direction (predetermined direction) G. Further, these plurality of grooves are arranged in a perpendicular direction OD perpendicular to the opening direction G, and a length of each of the grooves, in the opening direction G arranged in the perpendicular direction is as follows. Of the plurality of grooves, the length of a groove Tc as a first groove close to a center with respect to the perpendicular direction OD is longer than the lengths of grooves Te1 and Te2 as second grooves close to opposite end portions, respectively (Tc>Te1, Tc>Te2). That is, of the plurality of grooves, the groove Te1 and Te2 are positioned closer to the associated end portion than the groove Tc is with respect to the perpendicular direction OD.

Here, as shown in part (a) of FIG. 15, in the case where the opening direction G is an angle inclined relative to the direction Vc′ opposite to the sheet conveying direction Vc by an angle θ=45°, the uneven shape in the adhesive region AR2 of the sheet bundle SB is high in rigidity toward the opening direction G of the sheet bundle SB. That is, the uneven shape of the sheet bundle SB in the adhesive region AR2 having the right triangle shape strongly exhibits the effect, described in the first embodiment, by imparting the uneven shape to the sheet bundle SB.

On the other hand, in this embodiment, each of the heating plate 502 and the pressing plate 506 is formed in the right triangle shape in cross section, so that even in the case where a load is exerted on the corner-bound booklet (sheet bundle) in a direction other than a principal opening direction G (θ=45°), it becomes possible to obtain good adhesive strength. For example, part (c) of FIG. 15 shows an example in which an opening direction G′ is an angle θ=0° relative to the direction Vc′ opposite to the sheet conveying direction Vc, i.e., is parallel to the opposite direction Vc′. In such a case, although the effect by imparting the uneven shape to the sheet bundle SB is not readily obtained compared with the case where the opening direction is the opening direction G as shown in part (a) of FIG. 15, depending on a use case of a user, adhesive strength of a predetermined value or more is required in the adhesive region AR2.

A table 2 below is a result of comparison evaluation in which the adhesive strength by the tensile testing machine in this embodiment (second embodiment) is compared and evaluated with those of the first embodiment and a comparison example. Here, as regards the opening direction, for both of the opening direction G (θ 45°) and the opening direction G′ (θ=0°), the tensile test (comparison experiment) was conducted. Incidentally, in the tensile test, the thickness of the adhesive layer of each sheet bundle SB was 10 μm, and as the paper, the smooth paper (GF-C081) was used. Further, the comparison example is similar to the comparison example (with no uneven shape) compared in the first embodiment.

TABLE 2
TENSILE FORCE (N/cm)

| | G(45° DIRECTION) | | | G′(0° DIRECTION) | | |
|---|---|---|---|---|---|---|
| | EOE*¹ | | | | | |
| | 1E | 2E | CE | 1E | 2E | CE |
| AVERAGE | 1.3 | 1.4 | 0.5 | 0.6 | 1.1 | 0.2 |
| SAMPLE (1) | 1.5 | 1.5 | 0.2 | 0.5 | 1.2 | 0.1 |
| SAMPLE (2) | 1.2 | 1.3 | 0.5 | 0.6 | 1.1 | 0.3 |
| SAMPLE (3) | 1.3 | 1.4 | 0.4 | 0.5 | 1.1 | 0.2 |
| SAMPLE (4) | 1.4 | 1.4 | 0.9 | 0.7 | 1.0 | 0.4 |
| SAMPLE (5) | 1.3 | 1.3 | 0.3 | 0.6 | 1.1 | 0.2 |

*¹“EOE” is the embodiment or the comparison example. “1E” is the first embodiment, “2E” is the second embodiment, and “CE” is the comparison example.

First, in the case where the opening direction of the sheet bundle SB is the opening direction G (θ=45°), as described above in the first embodiment, when the first embodiment including the uneven shape and the comparison example including no uneven shape are compared with each other, the adhesive strength is higher in the first embodiment including the uneven shape in the adhesive layer than in the comparison example including no uneven shape (first embodiment)>(comparison example). On the other hand, when this embodiment (second embodiment) and the first embodiment are compared with each other, the adhesive strength in this embodiment was comparable to the adhesive strength in the first embodiment (first embodiment≈(second embodiment)).

Further, in the case where the opening direction of the sheet bundle SB is the opening direction G′ (θ=0°), in the first embodiment and the comparison example, the adhesive strength is lowered compared with the case of the opening direction G (θ=45°). On the other hand, in this embodiment, although the adhesive strength is somewhat lowered compared with the case of the opening direction G (θ=45°), the adhesive strength is capable of exceeding the reference value of 1.0 N/cm.

Parts (a) and (b) of FIG. 16 are schematic views and graphs for illustrating a difference in comparison experiment between this embodiment (second embodiment) and the first embodiment. Part (a) of FIG. 16 includes the schematic views of the comparison experiment between the first embodiment and the second embodiment in the opening direction G (θ 45°) and the graphs showing time transitions of tension in the comparison experiment. Part (b) of FIG. 16 includes the schematic views of the comparison experiment between the first embodiment and the second embodiment in the opening direction G′ (θ=0°) and the graphs showing time transitions of tension in the comparison experiment. In the schematic views shown in parts (a) and (b) of FIG. 16, “J” shows a portion where a maximum tension is obtained during opening (spread) of the sheet bundle, and dots (●) indicate uneven portions acting on the sheet bundle in the portion J. Incidentally, in the graphs of the time transitions of the tension, the portion J is a portion where the maximum tension is obtained under each condition, and “H” is a target value (2.4N) of the adhesive strength of the sheet bundle SB. As is understood from part (a) of FIG. 16, in the case of the opening direction G (θ=45°), in the first embodiment and the second embodiment, the number of the uneven portions acting in the portion J where the maximum tension is obtained is large in both the first embodiment and the second embodiment. Further, at this time, as is understood in the graphs of the time transitions of tension, in both embodiments, the tension exceeds the target value H of the adhesive strength, so that good adhesive strength can be obtained.

On the other hand, as is understood from part (b) of FIG. 16, in the case of the opening direction G′ (θ=0°), there is a difference between the first embodiment and the second embodiment. First, in the first embodiment, a lengths of the uneven portion in a central portion of the uneven shape is the same as lengths of the uneven portions in opposite end portions, and these are relatively short, and therefore, in the portion J where the maximum tension is obtained, the number of the uneven portions acting at the same time becomes small. As a result, as is understood from the graph of the time transition of tension, the number of the uneven portions acting at the same time is small and thus an effect of unevenness is dispersed, and therefore, although many peaks of the tension generate, a maximum value of the tension in the portion J is relatively small and is below the target value H of the adhesive strength.

Next, in the second embodiment, in the portion J where the maximum tension is obtained, the length of the uneven portion in a central portion of the uneven shape extending toward the direction of the corner of the sheet bundle SB is sufficiently long compared with the length of uneven portions in the opposite end portions, so that the uneven portions in a larger number can be caused to act at the same time. As a result, as is understood from the graph of the time transition of tension, many uneven portions can be caused to act at the same time, and therefore, the maximum value of the tension in the portion J is relatively large and thus is capable of exceeding the target value H of the adhesive strength.

As described above, in the second embodiment, the adhesive region AR2 having the substantially right triangle shape is formed correspondingly to the corner of the sheet bundle, so that high adhesive strength can be obtained. In the first embodiment, the strength is enhanced for the load from the opening direction G as the principal opening direction, while in the second embodiment, the strength can also be enhanced for the load from a direction other than the opening direction G. Incidentally, as regards the shape of the adhesive region and the direction of the uneven shape, suitable means may be selected in conformity to needs of a user using the apparatus.

### Modified Embodiment 1 of Second Embodiment

Here, in the second embodiment, each of an area of the first nipping surface 502a projected on XY plane and an area of the second nipping surface 506a projected on the XY plane is set to the same size as the adhesive region AR2, but is not limited thereto. Part (a) of FIG. 17 is a front view showing a first nipping surface 602a of a heating plate 602 in a modified embodiment 1 of the second embodiment, and part (b) of FIG. 17 is a side view showing the first nipping surface 602a of the heating plate 602. Part (c) of FIG. 17 is a front view showing a second nipping surface 606a of a pressing plate 606, and part (d) of FIG. 17 is a side view showing the second nipping surface 606a of the pressing plate 606. For example, as shown in parts (a) and (c) of FIG. 17, a thermocompression bonding portion in the modified embodiment 1 of the second embodiment includes the heating plate 602 having the first nipping surface 602a and the pressing plate 606 having the second nipping surface 606a.

In this modified embodiment 1, each of an area of the first nipping surface 602a projected on an XY plane and each of an area of the second nipping surface 606a projected on the XY plane is larger than the adhesive region AR2 (indicated by a white broken line). In order to form the adhesive region AR2 having a substantially right triangle shape in a corner of the sheet bundle SB, each of the first nipping surface 602a and the second nipping surface 606a is disposed so that a part thereof is protruded from the adhesive region AR2. Thus, in view of a size of the apparatus and ease of manufacturing of component parts, a shape and a size of each of the heating plate and the pressing plate can be appropriately selected.

### Modified Embodiment 2 of Second Embodiment

Further, in the embodiment 2, the shape of the adhesive region AR2 was the substantially right triangle shape, but is not limited thereto. For example, as an example of a modified embodiment 2 of the second embodiment, the shape of the adhesive region may be changed as shown in parts (a) and (b) of FIG. 18. For example, as shown in part (a) of FIG. 18, a constitution such that an adhesive region AR3 having a sector shape is formed on the sheet bundle SB by a first nipping surface 702a of a heating plate 702 and a second nipping surface 706a of a pressing plate 706 may be employed. Further, for example, as shown in part (b) of FIG. 18, a constitution such that an adhesive region AR4 having a lens shape is formed on the sheet bundle SB by a first nipping surface 802a of the heating plate 802 and a second nipping surface 806a of a pressing plate 806 may be employed. In either of adhesive regions AR3 and AR4, a plurality of grooves of each of the first nipping surface and the second nipping surface are arranged in a perpendicular direction OD perpendicular to an opening direction G and a length of a groove Tc close to a center of the plurality of grooves with respect to the perpendicular direction is longer than each of grooves Te1 and Te2 close to opposite end portions (Tc>Te1, Tc>Te2). By this, an effect similar to the effect of the second embodiment.

### Third Embodiment

Next, a third embodiment of the present disclosure will be described, but in the third embodiment, the shape of the second nipping surface 306a of the pressing plate 306 in the first embodiment is changed to a smooth shape. For this reason, constitutions similar to those in the first embodiment will be omitted from illustration or will be described by adding, thereto in the drawings, the same reference numerals or symbols.

FIG. 19 is a schematic view showing a thermocompression bonding portion 203B in a third embodiments. As shown in FIG. 19, the thermocompression bonding portion 203B includes a heating unit 31a, a receiving unit 41b, and a holding portion 31. The receiving unit 41b includes a supporting member 307 and a pressing plate 406 supported by the supporting member 307. The pressing plate 406 as a second nipping member is constituted by an elastic member such as a silicone rubber having a flat shape and of 0.5 to 5.0 mm in thickness and 60 degrees to 90 degrees in hardness, and has a heat-resistant property and is lower in thermo-conductivity than the heating plate 302. In other words, a flat surface of the second nipping surface 406a is lower in thermo-conductivity than a plurality of uneven portions provided on a first nipping surface 302a.

The pressing plate 406 includes the second nipping surface 406a opposing the first nipping surface 302a of the heating plate 302. The second nipping surface 406a as a second surface is constituted by a smooth surface smooth in a state in which an external force does not act thereon, and is press by the plurality of uneven portions of the first nipping surface 302a, so that the second nipping surface 406a is deformed along the plurality of uneven portions. The first nipping surface 302a and the second nipping surface 406a press the sheet bundle SB with a pressure distribution including high pressure and low pressure in an adhesive region AR by a difference in uneven amount of the plurality of uneven portions of the first nipping surface 302a. By this, the sheet bundle SB is bonded by an adhesive layer P1 in the adhesive region AR, and in addition, an uneven shape can be formed on the sheet bundle SB in the adhesive region AR.

Incidentally, it is not preferable that when hardness of the pressing plate 406 is excessively high, the uneven shape is not readily imparted to the sheet bundle SB. Further, it is not preferable from a viewpoint of quality (outer appearance) of the sheet bundle SB that when the hardness of the pressing plate 406 is excessively low, entirety of the second nipping surface 406a of the pressing plate 406 sinks into the first nipping surface 302a and traces such as depression remain in the adhesive region AR of the sheet bundle SB.

Also, in the constitution of this embodiment as described above, an effect similar to the effect of the first embodiment can be achieved. That is, the uneven shape is formed on the sheet bundle SB in the adhesive region AR, so that geometric moment of inertia of the sheet bundle SB can be increased, and therefore rigidity of the sheet bundle SB toward the principal opening direction G (see part (a) of FIG. 5), and adhesive strength (tensile strength) of the sheet bundle SB can be improved. Further, by forming a thick portion where a thickness of the adhesive layer P1 is locally thick, a toner consumption amount can be reduced, and in addition, the adhesive strength of the sheet bundle SB can be improved. Incidentally, also in this embodiment, when the tensile test was conducted similarly as in the first embodiment, good adhesive strength of the sheet bundle SB was capable of being obtained.

Further, the pressing plate 406 includes the smooth second nipping surface 406a, so that positional accuracy of the second nipping surface 406a relative to the uneven portions of the first nipping surface 302a is not so required, and therefore, the thermocompression bonding portion 203B can be constituted inexpensively. Further, a material having a heat-resistant property and low thermo-conductivity is used for the pressing plate 406, so that it is possible to suppress that heat of the heating plate 302 is dissipated into the pressing plate 406 through the sheet bundle SB, and thus the adhesive region AR of the sheet bundle SB can be efficiently heated.

### Modified Embodiment of Third Embodiment

Next, a modified embodiment of the third embodiment will be described, but in this modified embodiment, an arrangement of the heating plate 302 and the pressing plate 406 in the third embodiment is changed. As regards the heating plate 302 in the third embodiment described with reference to FIG. 19, as shown in part (a) of FIG. 20, the uneven shape was imparted to the sheet bundle SB by the plurality of uneven portions for which the opening direction G of the sheet bundle SB is a longitudinal direction. That is, each of the plurality of uneven portions of the first nipping surface 302a of the heating plate 302 extends parallel to the opening direction G.

Each of portions enclosed by broken lines in parts (a) and (b) of FIG. 20 shows one of the plurality of uneven portions formed on the first nipping surface 302a of the heating plate 302. The principal opening direction G is a direction from a toner image side for recording other than a toner image for bonding formed on the sheet bundle SB toward a corner side of the sheet bundle SB. In other words, the opening direction G is a direction from a central side toward a margin side of the sheet bundle SB. The uneven shape of the sheet bundle SB is formed by the plurality of uneven portions of the first nipping surface 302a of the heating plate 302 described above, so that rigidity of the sheet bundle SB toward the opening direction G can be improved.

On the other hand, in the modified embodiment of the third embodiment, as shown in part (b) of FIG. 20, a plurality of uneven portions of the first nipping surface 302a of the heating plate 302 extend in various directions. Specifically, the plurality of uneven portions of the first nipping surface 302a are arranged so that an interval between adjacent uneven portions becomes narrower on the central side than on the corner side of the sheet bundle SB. In other words, the plurality of uneven portions of the first nipping surface 302a are arranged in a sector shape. For example, one end portion T1 of the plurality of uneven portions extends in X direction which is a sheet width direction of the sheet bundle SB, and the other end portion T2 of the plurality of uneven portions extends in Y direction which is a lengthwise direction of the sheet bundle SB. By such a plurality of uneven portions of the first nipping surface 302a of the heating plate 302 in the adhesive region AR of the sheet bundle SB, the uneven shape along the plurality of the uneven portions is imparted. By this, not only the rigidity of the sheet bundle SB toward the principal opening direction G but also rigidity of the sheet bundle SB toward the sheet width direction (X direction) and the lengthwise direction (Y direction) can be improved. As a result, not only the adhesive strength of the sheet bundle SB with respect to the opening direction G but also the adhesive strength of the sheet bundle SB with respect to the sheet width direction (X direction) and the lengthwise direction (Y direction) can be improved. Incidentally, also in this modified embodiment, when a tensile test was conducted similarly as in the first embodiment, good adhesive strength of the sheet bundle SB was capable of being obtained.

Further, it is of course that the arrangement of the plurality of uneven portions of the heating plate 302 as in this modified embodiment is also applicable to the first embodiment. In this case, the plurality of uneven portions provided on the second nipping surface 306a of the pressing plate 306 are also disposed so as to engage with the plurality of uneven portions of the heating plate 302, respectively, as shown in part (b) of FIG. 20.

### Fourth Embodiment

Next, a fourth embodiment of the present disclosure will be described, but in the fourth embodiment, the shape of the plurality of portions of the heating plate 302 in the third embodiment is changed. For this reason, constitutions similar to those in the third embodiment will be omitted from illustration or will be described by adding, thereto in the drawings, the same reference numerals or symbols.

Part (a) of FIG. 21 is a perspective view of a heating plate 502 in the fourth embodiment, part (b) of FIG. 21 is a schematic view showing a plurality of uneven portions having a double-cut shape, and part (c) of FIG. 21 is a sectional view showing the plurality of uneven portions.

As shown in parts (a) to (c) of FIG. 21, the heating plate 502 includes a first nipping surface 502a capable of pressing the sheet bundle SB. The first nipping surface 502a is provided with the plurality of uneven portions. These uneven portions have a so-called “double-cut” shape formed by a plurality of first grooves 502b parallel to a first direction D1 and a plurality of second grooves 502c parallel to a second direction D2 crossing the first direction D1. The plurality of first grooves 502b are an example of a plurality of third grooves, and the plurality second grooves 502c are an example of a plurality of fourth grooves. Such “double-cut” shape may only be required to have a size such that the “double-cut” shape is capable of imparting the uneven shape to the sheet bundle SB. The “double-cut” shape in this embodiment was formed in a manner such that an aluminum plate is processed so that two rows each including 13 quadrangular pyramids each having a size of 1.5 mm (length)×1.5 mm (width)×0.5 mm (height) are arranged so as to form grooves crossing at 90°.

Incidentally, in this embodiment, the above-described quadrangular pyramids were used, but from viewpoints of quality and an operating property, a size of each quadrangular pyramid may preferably be in a range of 1.0 mm to 2.0 mm in length, 1.0 mm to 2.0 mm in width, and 0.1 mm to 1 mm in height. As regards the height of each quadrangular pyramid, when the height is excessively low, it is not preferable that the sheet bundle SB is hard to be deformed (the uneven shape is hard to be imparted), and when the height is excessively height, it is not preferable that the quality is deteriorated in some cases by breakage of the sheet bundle SB. Similarly, as regards the size of each quadrangular pyramid with respect to the length and the width, when the size is excessively small, the sheet bundle SB is hard to be deformed, and when the size is excessively large, an effect of imparting the uneven shape to the sheet bundle SB becomes small.

Also, in the constitution of this embodiment as described above, an effect similar to those of the first embodiment, the second embodiment, and the third embodiment can be achieved. That is, the uneven shape is formed on the sheet bundle SB in the adhesive region AR, so that geometric moment of inertia of the sheet bundle SB can be increased, and therefore rigidity of the sheet bundle SB toward the principal opening direction G, and adhesive strength (tensile strength) of the sheet bundle SB can be improved. Further, by forming a thick portion where a thickness of the adhesive layer P1 is locally thick, a toner consumption amount can be reduced, and in addition, the adhesive strength of the sheet bundle SB can be improved. Incidentally, also in this embodiment, when tensile test was conducted similarly as in the first embodiment, good adhesive strength of the sheet bundle SB was capable of being obtained.

Incidentally, in this embodiment, the example of the “double-cut” shape such that the grooves are formed while crossing at 90° was shown, but a constitution in which a plurality of uneven shapes are randomly provided may also be employed. Further, it is of course that the arrangement of the plurality of uneven portions having the “double-cut” shape as in this embodiment is also applicable to the first embodiment. In this case, the plurality of uneven portions provided on the second nipping surface 306a of the pressing plate 306 are also formed in the “double-cut” surface as shown in parts (a) to (c) of FIG. 21.

### Other Embodiments

Incidentally, in the third embodiment, the first nipping surface 302a of the heating plate 302 was provided with the plurality of uneven portions and the second nipping surface 406a of the pressing plate 406 was constituted by the smooth surface, but the present disclosure is not limited thereto. For example, the first nipping surface of the heating plate is constituted by the smooth surface, and the second nipping surface of the pressing plate may be provided with the plurality of uneven portions. That is, at least one of the first nipping surface and the second nipping surface may only be required to be provided with the plurality of uneven portions for forming the uneven shape on the sheet bundle SB in the adhesive region AR.

Further, a constitution in which the first nipping surface 302a is provided with one projected portion and one recessed portion and in which the second nipping surface 306a is constituted by the smooth surface may be employed. On the other hand, a constitution in which the second nipping surface 306a is provided with one projected portion and one recessed portion and in which the first nipping surface 302a is constituted by the smooth surface. That is, the first nipping surface (first surface) or the second nipping surface (second surface) may only be provided with one projected portion or one recessed portion. Further, either one of the first nipping surface 302a and the second nipping surface 306a is provided with one projected portion, and the other nipping surface first nipping surface 302a and the second nipping surface 306a may be provided with one recessed portion. That is, the first nipping surface 302a and the second nipping surface 306a may only be required so as to form the uneven shape on the sheet bundle SB in the adhesive region AR by nipping the sheet bundle SB.

Further, in either one of the above-described embodiments, the thermocompression bonding portion 203 or 203B was constituted so as to form the uneven shape on the sheet bundle SB in the adhesive region AR, but a thermocompression bonding portion in which the uneven shape is not formed on the sheet bundle SB may be further provided separately (this thermocompression bonding portion is referred to as no uneven thermocompression bonding portion). In this case, depending on use (purpose), whether to use the thermocompression bonding portion 203 or 203B in which the uneven shape is formed on the sheet bundle SB or to use the no uneven thermocompression bonding portion may be selected. For example, an operation in an adhesive force priority mode in which the adhesive force of the sheet bundle SB is prioritized, the thermocompression bonding portion 203 or 203B may be used, and in an operation in an appearance priority mode in which appearance of the sheet bundle SB is prioritized, the no thermocompression bonding portion may be used.

Further, in either one of the above-described embodiments, the plurality of uneven portions provided on the first nipping surface 302a of the heating plate 302 and the second nipping surface 306a of the pressing plate 306 have the same height and the same pitch, but are not limited thereto. The plurality of uneven portions may also be constituted so as to have different heights and different pitches. Further, in the first to third embodiments, the plurality of grooves formed on the plurality of uneven portions were formed so as to extend parallel to the opening direction G, but are not limited thereto. For example, the plurality of grooves may extend in a direction crossing the opening direction G, and the grooves are not necessarily required to be arranged in parallel to each other.

### Summary of the Present Disclosure

The present disclosure includes at least the following contents (constitutions).

### (Constitution 1)

A sheet bonding apparatus comprising:
a first nipping member having a first surface and configured to nip a sheet bundle on which a toner image for bonding sheets together is formed;
a heating portion configured to heat the first surface of the first nipping member; and
a second nipping member having a second surface opposing the first surface and configured to bond the sheet bundle in an adhesive region by heating and pressing the toner image while nipping the sheet bundle by the first surface and the second surface,
wherein at least one of the first surface and the second surface includes a plurality of uneven portions for forming an uneven shape on the sheet bundle in the adhesive region.

### (Constitution 2)

The sheet bonding apparatus according to the constitution 1, wherein the first surface includes a plurality of first uneven portions as the plurality uneven portions, and
wherein the second surface includes a plurality of second uneven portions for forming an uneven shape on the sheet bundle by being engaged with the plurality of first uneven portions each other.

### (Constitution 3)

The sheet bonding apparatus according to the constitution 2, wherein the plurality of first uneven portions include projections and recesses, and the plurality of second uneven portions projections and recesses, and
wherein a height difference between each projection and each recess of the plurality of first uneven portions is different from a height difference between each projection and each recess of the plurality of second uneven portions.

### (Constitution 4)

The sheet bonding apparatus according to the constitution 1, wherein either one of the first surface and the second surface includes the plurality of uneven portions, and the other one of the first surface and the second surface includes a smooth surface opposing the plurality of uneven portions, and
wherein the smooth surface is constituted by an elastic member.

### (Constitution 5)

The sheet bonding apparatus according to the constitution 4, wherein the smooth surface is lower in thermal conductivity than the plurality of uneven portions.

### (Constitution 6)

The sheet bonding apparatus according to any one of the constitutions 1 to 5, wherein the plurality of uneven portions are formed so that a thickness of the toner image heated and pressed by the first surface and the second surface is non-uniform.

### (Constitution 7)

The sheet bonding apparatus according to any one of the constitutions 1 to 6, wherein the plurality of uneven portions are formed by a plurality of grooves parallel to a predetermined direction.

### (Constitution 8)

The sheet bonding apparatus according to the constitution 7, wherein the plurality of uneven portions include the plurality of grooves including a first groove and a second groove positioned closer to an end portion than the first groove is with respect to a perpendicular direction to the predetermined direction, and
wherein with respect to the predetermined direction, the first groove is longer than the second groove.

### (Constitution 9)

The sheet bonding apparatus according to the constitution 8, wherein the adhesive region has a substantially right triangle shape.

### (Constitution 10)

The sheet bonding apparatus according to the constitution 7, wherein the predetermined direction is a direction along an opening direction of the sheet bundle.

### (Constitution 11)

The sheet bonding apparatus according to the constitution 77, wherein the predetermined direction is a direction from a center side toward a corner side of the sheet bundle.

### (Constitution 12)

The sheet bonding apparatus according to any one of the constitutions 1 to 6, wherein the plurality of uneven portions are arranged so that an interval between adjacent uneven portions becomes narrower on a margin side of the sheet bundle than on a center side of the sheet bundle.

### (Constitution 13)

The sheet bonding apparatus according to any one of the constitutions 1 to 6, wherein the plurality of uneven portions are formed by a plurality of third grooves parallel to a first direction and a plurality of fourth grooves parallel to a second direction crossing the first direction.

### (Constitution 14)

A sheet bonding apparatus comprising:
a first nipping member having a first surface and configured to nip a sheet bundle on which a toner image for bonding sheets together is formed;
a heating portion configured to heat the first surface of the first nipping member; and
a second nipping member having a second surface opposing the first surface and configured to bond the sheet bundle in an adhesive region by heating and pressing the toner image while nipping the sheet bundle by the first surface and the second surface,
wherein the first surface and the second surface are constituted so as to form an uneven shape on the sheet bundle in the adhesive region by nipping the sheet bundle therebetween.

### (Constitution 15)

A sheet processing apparatus comprising:
a stacking portion on which a sheet bundle is stacked;
an aligning portion configured to align the sheet bundle stacked on the stacking portion; and
a sheet bonding apparatus according to any one of the constitutions 1 to 14 in which the sheet bundle aligned by the aligning portion is bonded.

### (Constitution 16)

An image forming apparatus comprising:
a main assembly configured to form an image on a sheet; and
a sheet processing apparatus according to the constitution 15 in which a plurality of sheets each on which the image is formed by the main assembly are bonded together.

### (Constitution 17)

The image forming apparatus according to claim 16, wherein the main assembly forms a first toner image for forming images on sheets and a second toner image as the toner image for bonding the sheets together are formed on the sheets.

According to the present disclosure, adhesive strength of the sheet bundle can be improved.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Applications Nos. 2024-174750, filed on Oct. 4, 2024, and 2025-148621, filed on Sep. 8, 2025, which are hereby incorporated by reference herein in their entirety.

What is claimed is:

1. A sheet bonding apparatus comprising:
a first nipping member having a first surface and configured to nip a sheet bundle on which a toner image for bonding sheets together is formed;
a heating portion configured to heat the first surface of the first nipping member; and
a second nipping member having a second surface opposing the first surface and configured to bond the sheet bundle in an adhesive region by heating and pressing the toner image while nipping the sheet bundle by the first surface and the second surface,
wherein at least one of the first surface and the second surface includes a plurality of uneven portions for forming an uneven shape on the sheet bundle in the adhesive region.

2. The sheet bonding apparatus according to claim 1, wherein the first surface includes a plurality of first uneven portions as the plurality uneven portions, and
wherein the second surface includes a plurality of second uneven portions for forming an uneven shape on the sheet bundle by being engaged with the plurality of first uneven portions each other.

3. The sheet bonding apparatus according to claim 2, wherein the plurality of first uneven portions include projections and recesses, and the plurality of second uneven portions projections and recesses, and
wherein a height difference between each projection and each recess of the plurality of first uneven portions is different from a height difference between each projection and each recess of the plurality of second uneven portions.

4. The sheet bonding apparatus according to claim 1, wherein either one of the first surface and the second surface includes the plurality of uneven portions, and the other one of the first surface and the second surface includes a smooth surface opposing the plurality of uneven portions, and
wherein the smooth surface is constituted by an elastic member.

5. The sheet bonding apparatus according to claim 4, wherein the smooth surface is lower in thermal conductivity than the plurality of uneven portions.

6. The sheet bonding apparatus according to claim 1, wherein the plurality of uneven portions are formed so that a thickness of the toner image heated and pressed by the first surface and the second surface is non-uniform.

7. The sheet bonding apparatus according to claim 1, wherein the plurality of uneven portions are formed by a plurality of grooves parallel to a predetermined direction.

8. The sheet bonding apparatus according to claim 7, wherein the plurality of uneven portions include the plurality of grooves including a first groove and a second groove positioned closer to an end portion than the first groove is with respect to a perpendicular direction to the predetermined direction, and
wherein with respect to the predetermined direction, the first groove is longer than the second groove.

9. The sheet bonding apparatus according to claim 8, wherein the adhesive region has a substantially right triangle shape.

10. The sheet bonding apparatus according to claim 7, wherein the predetermined direction is a direction along an opening direction of the sheet bundle.

11. The sheet bonding apparatus according to claim 7, wherein the predetermined direction is a direction from a center side toward a corner side of the sheet bundle.

12. The sheet bonding apparatus according to claim 1, wherein the plurality of uneven portions are arranged so that an interval between adjacent uneven portions becomes narrower on a margin side of the sheet bundle than on a center side of the sheet bundle.

13. The sheet bonding apparatus according to claim 1, wherein the plurality of uneven portions are formed by a plurality of third grooves parallel to a first direction and a plurality of fourth grooves parallel to a second direction crossing the first direction.

14. A sheet bonding apparatus comprising:
a first nipping member having a first surface and configured to nip a sheet bundle on which a toner image for bonding sheets together is formed;
a heating portion configured to heat the first surface of the first nipping member; and
a second nipping member having a second surface opposing the first surface and configured to bond the sheet bundle in an adhesive region by heating and pressing the toner image while nipping the sheet bundle by the first surface and the second surface,
wherein the first surface and the second surface are constituted so as to form an uneven shape on the sheet bundle in the adhesive region by nipping the sheet bundle therebetween.

15. A sheet processing apparatus comprising:
a stacking portion on which a sheet bundle is stacked;
an aligning portion configured to align the sheet bundle stacked on the stacking portion; and
a sheet bonding apparatus according to claim 1 in which the sheet bundle aligned by the aligning portion is bonded.

16. An image forming apparatus comprising:
a main assembly configured to form an image on a sheet; and
a sheet processing apparatus according to claim 15 in which a plurality of sheets each on which the image is formed by the main assembly are bonded together.

17. The image forming apparatus according to claim 16, wherein the main assembly forms a first toner image for forming images on sheets and a second toner image as the toner image for bonding the sheets together are formed on the sheets.

18. A sheet processing apparatus comprising:
a stacking portion on which a sheet bundle is stacked;
an aligning portion configured to align the sheet bundle stacked on the stacking portion; and
a sheet bonding apparatus according to claim 14 in which the sheet bundle aligned by the aligning portion is bonded.

19. An image forming apparatus comprising:
a main assembly configured to form an image on a sheet; and
a sheet processing apparatus according to claim 18 in which a plurality of sheets each on which the image is formed by the main assembly are bonded together.

20. The image forming apparatus according to claim 19, wherein the main assembly forms a first toner image for forming images on sheets and a second toner image as the toner image for bonding the sheets together are formed on the sheets.
